(19) United States
(12) Patent Application Publication
(10) Pub. No.: US 2019/0234809 A1
(43) Pub. Date: Aug. 1, 2019

(54) SPATIAL RESOLUTION OF A DTS SYSTEM BY IMPULSE RESPONSE DECONVOLUTION AND OPTIMIZATION ALGORITHMS

(71) Applicant: NEC Laboratories America, Inc., Princeton, NJ (US)

(72) Inventors: Yaowen LI, PRINCETON, NJ (US); Jiaming LIANG, ATLANTA, GA (US)

(73) Assignee: NEC LABORATORIES AMERICA, INC, PRINCETON, NJ (US)

(21) Appl. No.: 16/258,587

(22) Filed: Jan. 26, 2019

Related U.S. Application Data
(60) Provisional application No. 62/622,204, filed on Jan. 26, 2018.

(51) Int. Cl. G01K 11/32

(52) U.S. Cl. CPC G01K 11/32; G01K 2011/324

(57) ABSTRACT

Aspects of the present disclosure describe Raman based Distributed temperature sensing (DTS) systems with a novel recovery algorithm that improves the spatial resolution of DTS system. The algorithm is based on a linear DTS model and weighted total variation. Furthermore, we describe an additional algorithm which can automatically detect and recover any hot regions along the fiber—with the recovery algorithm as its core—achieving correct reconstruction with a temperature profile down to 10 cm in length—which is equivalent to improving the spatial resolution to about 5 cm

### CROSS REFERENCE TO RELATED APPLICATIONS

This application claims the benefit of Untied States Provisional Patent Application Ser. No. 62/622,204 filed 26 Jan. 2018 the entire contents of which is incorporated by reference as if set forth at length herein.

### TECHNICAL FIELD

This disclosure relates generally to sensing systems, methods, and structures. More particularly, it pertains to Raman-based distributed temperature sensing (DTS).

### BACKGROUND

Distributed temperature sensing systems are optoelectronic systems that measure temperatures by means of optical fibers functioning as linear sensors. Generally, temperatures are recorded along the optical sensor cable as a continuous profile. As is known, such systems provide a high accuracy of temperature determination over great distances and may exhibit the ability to locate temperatures to a spatial resolution of 1 m with an accuracy to within ±0.01° C. over measurement distances greater than 30 km. As a consequence, such systems have found widespread use in contemporary applications including: oil and gas exploration and production, power cable and transmission line monitoring, fire detection, industrial surveillance, integrity of liquid natural gas (LNG) carriers and terminals, temperature monitoring in plant and process engineering including transmission pipelines, and ecological monitoring including stream temperature, and groundwater detection—among others.

Given the utility and importance of DTS systems and methods, improvements thereto would be a welcome addition to the art.

### SUMMARY

An advance in the art is made according to aspects of the present disclosure directed to an improved method for Raman based Distributed temperature sensing (DTS) system utilizing a novel recovery method to improve the spatial resolution of the DTS system. The method is based on a linear DTS model and weighted total variation. Of further advantage, an enhanced method which automatically detects and recovers any hot regions along the fiber, is described—with the novel recovery method as its core.

In sharp contrast to the prior art, DTS system(s) employing our novel methods may advantageously achieve correct reconstruction with a temperature profile down to 10 cm in length—which is equivalent to improving the spatial resolution to about 5 cm.

As will become readily apparent to those skilled in the art, systems and methods according to the present disclosure are: simple and robust with less uncertainty and errors; eliminate unwanted noise through the use of a weighted regularization parameter method, ensuring the accurate temperature recovers; recover accurate temperatures for short lengths of fiber by matching recovered and measured response shapes with auto-tuning methods; and are readily implementable in a DTS.

### BRIEF DESCRIPTION OF THE DRAWING

A more complete understanding of the present disclosure may be realized by reference to the accompanying drawing in which:

FIG. 1 is a plot illustrating a definition of DTS spatial resolution;

FIG. 2 is a schematic diagram illustrating an experimental setup according to aspects of the present disclosure;

FIG. 3 is a schematic diagram illustrating a linear DTS system according to aspects of the present disclosure;

FIG. 4 is a plot illustrating a Toeplitz matrix H according to aspects of the present disclosure;

FIG. 5 is a temperature profile plot of temperature ° C. vs. position/m illustrating 50° C. training data according to aspects of the present disclosure.

FIG. 6 is a temperature profile plot at 50° C. of temperature ° C. vs. position/m for a 3 m construction according to aspects of the present disclosure.

FIG. 7 is a temperature profile plot at 70° C. of temperature ° C. vs. position/m for a 3 m construction according to aspects of the present disclosure.

FIG. 8 is a temperature profile plot at 70° C. of temperature ° C. vs. position/m for a 2.8 m construction according to aspects of the present disclosure.

FIG. 9 is a temperature profile plot at 70° C. of temperature ° C. vs. position/m for a 2.5 m construction according to aspects of the present disclosure.

FIG. 10 is a temperature profile plot at 70° C. of temperature ° C. vs. position/m for a 2.2 m construction according to aspects of the present disclosure.

FIG. 11 is a temperature profile plot at 70° C. of temperature ° C. vs. position/m for a 2 m construction according to aspects of the present disclosure.

FIG. 12 is a temperature profile plot at 70° C. of temperature ° C. vs. position/m for a 1.8 m construction according to aspects of the present disclosure.

FIG. 13 is a temperature profile plot at 70° C. of temperature ° C. vs. position/m for a 1.5 m construction according to aspects of the present disclosure.

FIG. 14 is a temperature profile plot at 70° C. of temperature ° C. vs. position/m for a 1.2 m construction according to aspects of the present disclosure.

FIG. 15 is a temperature profile plot at 70° C. of temperature ° C. vs. position/m for a 1 m construction according to aspects of the present disclosure.

FIG. 16 is a temperature profile plot at 70° C. of temperature ° C. vs. position/m for a 80 cm construction according to aspects of the present disclosure.

FIG. 17 is a temperature profile plot at 70° C. of temperature ° C. vs. position/m for a 50 cm construction according to aspects of the present disclosure.

FIG. 18 is a temperature profile plot at 70° C. of temperature ° C. vs. position/m for a 40 cm construction according to aspects of the present disclosure.

FIG. 19 is a temperature profile plot at 70° C. of temperature ° C. vs. position/m for a 20 cm construction according to aspects of the present disclosure.

FIG. 20 is a temperature profile plot at 70° C. of temperature ° C. vs. position/m for a 10 m construction according to aspects of the present disclosure.

FIG. 21 is a 1 m temperature profile plot of temperature ° C. vs. position/m for an 85° C. construction according to aspects of the present disclosure.

FIG. 22 is a 1 m temperature profile plot of temperature ° C. vs. position/m for a 65° C. construction according to aspects of the present disclosure.

FIG. 23 is a 1 m temperature profile plot of temperature ° C. vs. position/m for a 50° C. construction according to aspects of the present disclosure.

FIG. 24 is a 1 m temperature profile plot of temperature ° C. vs. position/m for a 10° C. construction according to aspects of the present disclosure.

FIG. 25 is a 1 m temperature profile plot of temperature ° C. vs. position/m for a 2.1° C. construction according to aspects of the present disclosure.

FIG. 26 is a 50° C. temperature profile plot of temperature ° C. vs. position/m for a 3 m construction according to aspects of the present disclosure.

FIG. 26 is a 50° C. temperature profile plot of temperature ° C. vs. position/m for a 2 m construction according to aspects of the present disclosure.

FIG. 27 is a 50° C. temperature profile plot of temperature ° C. vs. position/m for a 2 m construction according to aspects of the present disclosure.

FIG. 28 is a 50° C. temperature profile plot of temperature ° C. vs. position/m for a 1.5 m construction according to aspects of the present disclosure.

FIG. 29 is a 50° C. temperature profile plot of temperature ° C. vs. position/m for a 1 m construction according to aspects of the present disclosure.

FIG. 30 is a 50° C. temperature profile plot of temperature ° C. vs. position/m for a 50 cm construction according to aspects of the present disclosure.

FIG. 31 is a 50° C. temperature profile plot of temperature ° C. vs. position/m for a 40 cm construction according to aspects of the present disclosure.

FIG. 32 is a 50° C. temperature profile plot of temperature ° C. vs. position/m for a 20 cm construction according to aspects of the present disclosure.

FIG. 33 is a 50° C. temperature profile plot of temperature ° C. vs. position/m for a 10 cm construction according to aspects of the present disclosure.

FIG. 34 is a schematic diagram illustrating signal recovery according to aspects of the present disclosure.

FIG. 35 is a 50° C. temperature profile plot of temperature ° C. vs. position/m for a 20 cm λ=1 construction according to aspects of the present disclosure.

FIG. 36 is a 50° C. temperature profile plot of temperature ° C. vs. position/m for a 20 cm λ=0.1 construction according to aspects of the present disclosure.

FIG. 37 is a 50° C. temperature profile plot of temperature ° C. vs. position/m for a 20 cm λ=0.02 construction according to aspects of the present disclosure.

FIG. 38 is a 50° C. temperature profile plot of temperature ° C. vs. position/m for a weighted total variation according to aspects of the present disclosure.

FIG. 39 is a 10° C. temperature profile plot of temperature ° C. vs. position/m for a 10° C. 3 m reconstruction according to aspects of the present disclosure.

FIG. 40 is a 10° C. temperature profile plot of temperature ° C. vs. position/m for a 10° C. 2 m reconstruction according to aspects of the present disclosure.

FIG. 41 is a 10° C. temperature profile plot of temperature ° C. vs. position/m for a 10° C. 1.5 m reconstruction according to aspects of the present disclosure.

FIG. 42 is a 10° C. temperature profile plot of temperature ° C. vs. position/m for a 10° C. 1 m reconstruction according to aspects of the present disclosure.

FIG. 43 is a 10° C. temperature profile plot of temperature ° C. vs. position/m for a 10° C. 50 cm reconstruction according to aspects of the present disclosure.

FIG. 44 is a 10° C. temperature profile plot of temperature ° C. vs. position/m for a 10° C. 40 cm reconstruction according to aspects of the present disclosure.

FIG. 45 is a 10° C. temperature profile plot of temperature ° C. vs. position/m for a 10° C. 20 cm reconstruction according to aspects of the present disclosure.

FIG. 46 is a 70° C. temperature profile plot of temperature ° C. vs. position/m for a 70° C. 3 m reconstruction on signal with single hot source according to aspects of the present disclosure.

FIG. 47 is a 70° C. temperature profile plot of temperature ° C. vs. position/m for a 70° C. 2.8 m reconstruction on signal with single hot source according to aspects of the present disclosure.

FIG. 48 is a 70° C. temperature profile plot of temperature ° C. vs. position/m for a 70° C. 2.5 m reconstruction on signal with single hot source according to aspects of the present disclosure.

FIG. 49 is a 70° C. temperature profile plot of temperature ° C. vs. position/m for a 70° C. 2 m reconstruction on signal with single hot source according to aspects of the present disclosure.

FIG. 50 is a 70° C. temperature profile plot of temperature ° C. vs. position/m for a 70° C. 1 m reconstruction on signal with single hot source according to aspects of the present disclosure.

FIG. 51 is a 70° C. temperature profile plot of temperature ° C. vs. position/m for a 70° C. 40 cm reconstruction on signal with single hot source according to aspects of the present disclosure.

FIG. 52 is a 70° C. temperature profile plot of temperature ° C. vs. position/m for a 70° C. 20 cm reconstruction on signal with single hot source according to aspects of the present disclosure.

FIG. 53 is a 70° C. temperature profile plot of temperature ° C. vs. position/m for a 70° C. 10 cm reconstruction on signal with single hot source according to aspects of the present disclosure.

FIG. 54 is a 70° C. temperature profile plot of temperature ° C. vs. position/m for a 70° C. 3 m reconstruction on signal with multiple hot sources according to aspects of the present disclosure.

FIG. 55 is a 70° C. temperature profile plot of temperature ° C. vs. position/m for a 70° C. reconstruction on signal with multiple hot sources according to aspects of the present disclosure.

FIG. 56 is a 60° C. temperature profile plot of temperature ° C. vs. position/m for a 70° C. illustrating hot regions separated by 50 cm according to aspects of the present disclosure.

FIG. 57 is a 60° C. temperature profile plot of temperature ° C. vs. position/m for a 70° C. illustrating measurement merged according to aspects of the present disclosure.

FIG. 58 is a prominence plot of signal with separation of 350 cm according to aspects of the present disclosure.

FIG. 59 is a prominence plot of signal with separation of 50 cm according to aspects of the present disclosure.

FIG. 60 is a 60° C. temperature profile plot of temperature ° C. vs. position/m illustrating 350 cm separation according to aspects of the present disclosure.

FIG. 61 is a 60° C. temperature profile plot of temperature ° C. vs. position/m illustrating 300 cm separation according to aspects of the present disclosure.

FIG. 62 is a 60° C. temperature profile plot of temperature ° C. vs. position/m illustrating 250 cm separation according to aspects of the present disclosure.

FIG. 63 is a 60° C. temperature profile plot of temperature ° C. vs. position/m illustrating 200 cm separation according to aspects of the present disclosure.

FIG. 64 is a 60° C. temperature profile plot of temperature ° C. vs. position/m illustrating 150 cm separation according to aspects of the present disclosure.

FIG. 65 is a 60° C. temperature profile plot of temperature ° C. vs. position/m illustrating 100 cm separation according to aspects of the present disclosure.

FIG. 66 is a 60° C. temperature profile plot of temperature ° C. vs. position/m illustrating 50 cm separation according to aspects of the present disclosure; and

FIG. 67 is a flow diagram illustrating method steps that provide a number of advantages over the art and according to aspects of the present disclosure.

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

### INTRODUCTION

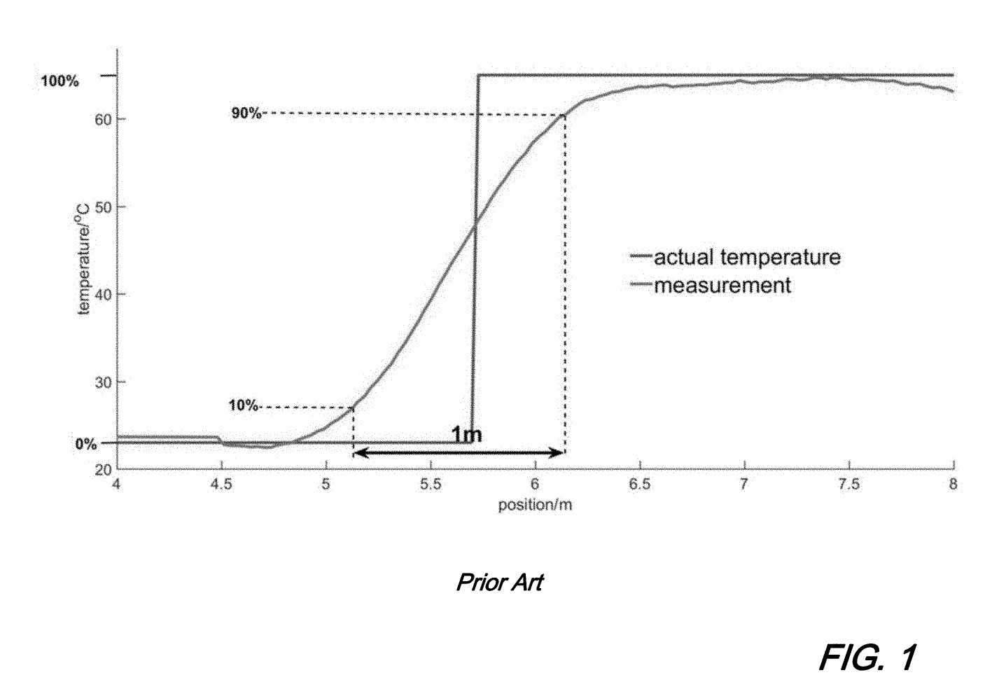

By way of some additional background, we begin by noting that spatial resolution is generally understood to be a spatial distance between the 10% and 90% levels of the response to a temperature step. As shown in FIG. 1,—which is a plot useful in illustrating DTS spatial resolution—sych systems may exhibit a spatial resolution of 1 m. In general, for a temperature profile described by a step impulse with length smaller than the spatial resolution, the measured temperature will be lower than the real temperature. Thus, this characteristic can be a disadvantage of the DTS system, and sometimes limits its use in certain applications where thermal variations occur in regions with the lengths shorter than 1 m.

From a hardware point of view, several studies for improvement in spatial resolution of DTS system have been presented in the literature (See, e.g., João Paulo Bazzo, Daniel Rodrigues Pipa, Cicero Martelli, Erlon Vagner da Silva, and Jean Carlos Cardozo da Silva. Improving Spatial Resolution of Raman DTS Using Total Variation Deconvolution. IEEE Sensors Journal, 16(11):4425-4430, 2016; Stephen Boyd, Neal Parikh, Eric Chu, Borja Peleato, and Jonathan Eckstein. Distributed Optimization and Statistical Learning via the Alternating Direction Method of Multipliers. Foundations and Trends® in Machine Learning, 3(1):1-122, 2011; and Stanley H Chan, Ramsin Khoshabeh, Kristofor B Gibson, Philip E Gill, and Truong Q Nguyen. An Augmented Lagrangian Method for Total Variation Video Restoration. IEEE Transactions on Image Processing, 20(11):3097-3111, 2011.)

Note, however, such techniques oftentimes exhibit a higher cost, or other complications including equipment design and/or undesirable performance characteristics including an increase in the response time and in uncertainty of measurement.

Another alternative approach to improving spatial resolution involves using signal processing techniques. More particularly, proposals have been made to use a deconvolution algorithm for improving the spatial resolution of a commercial Raman DTS system. The algorithm uses a linear model for the DTS system, which was empirically determined, and a total variation reconstruction approach to estimate hot regions with lengths shorter than 1 m. Such techniques have shown promise for providing enhancement in DTS spatial resolution without increasing equipment costs—without requiring physical changes in the device. Notwithstanding such promise, improvements remain necessary as such approaches have suffered from at least the following drawbacks:
System identification requires a Laplace transform, estimation of poles and zeros, and an inverse Laplace transform. Calculation involved is complicated and number of poles and zeros might introduce undesired uncertainty and error.
Temperature profile cannot be reconstructed when the fiber is very short (under 15 cm), and noise induced is problematic.

Generally speaking—and as will be appreciated by those skilled in the art, a profile reconstruction problem is an inverse problem, therefore we need to learn the system first and then solve the inverse problem. Thus, the process needs to be divided into two parts: system identification and signal recovery. And while our general approach is built upon the linear system and deconvolution theory, we advantageously have developed new and improved algorithms and procedures to better identify the system in both temperature and length spaces and more accurately recover the real temperature profiles.

Specifically, the new algorithms and procedures are in the following areas:
For system identification, the DTS system is characterized as a sensitivity matrix H by solving a convex program. By avoiding Laplace transform, system identification and inverse Laplace transform, there is no parameter (number of poles and zeros) to be tuned, thus the system is deterministic without dependence on any parameter.
For signal recovery, a weighted total variation model is proposed to reconstruct the temperature profile with high fidelity and control the noise introduced in the reconstruction process and a very simple but powerful algorithm ADMM is used to solve the minimization problem.

Moreover, we developed an algorithm to recover arbitrary temperature profile by finding all the hot regions and using the recovery algorithm to recover each small piece of signal locally.

### DTS System Configuration

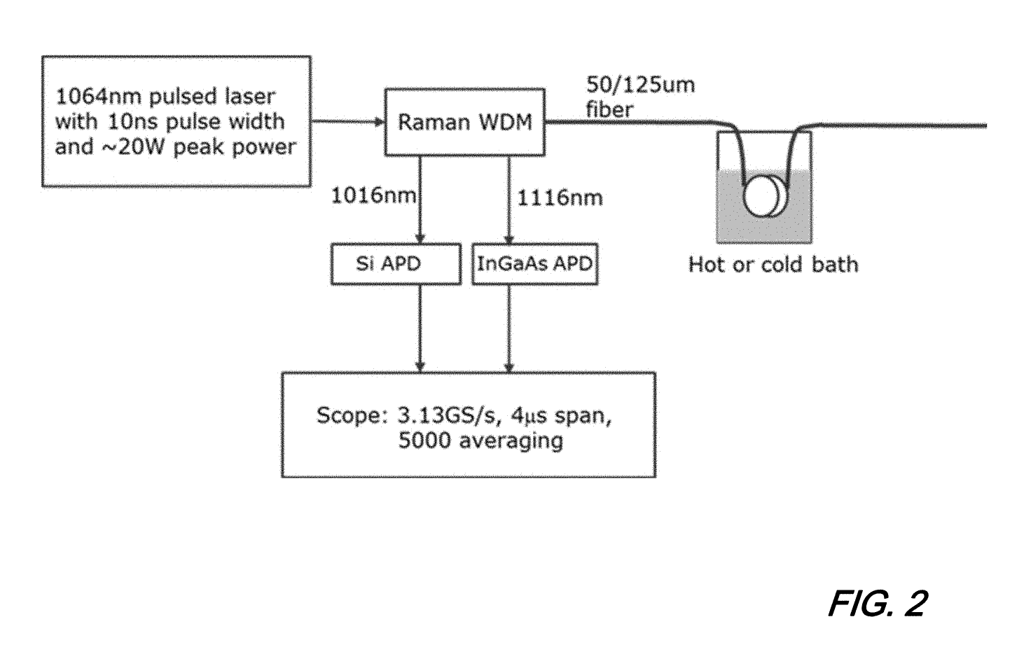

An illustrative DTS system used in our work is a breadboard 1064 nm system illustratively shown in FIG. 2. Operationally, the pulse width was set at 10 ns, the repetition rate was at 10 KHz, the optical pulse peak power was set at ˜20 W, and the fiber used in the tests was the 50/125 um multimode fiber. A Tektronix digital scope with a 20 GHz bandwidth was set at 3.13 GS/s sampling rate and with 5000 averaging. The fiber coils with different lengths were placed in a hot bath with the temperatures controlled to within +/−0.1 C of the set points to give the system impulse inputs. The stokes and anti-Stokes outputs from APD detectors were saved and processed in MATLAB to obtain the temperature data. All the algorithms and procedures developed in this work were applied to the processed temperature data.

### Recovery Algorithm

System Identification

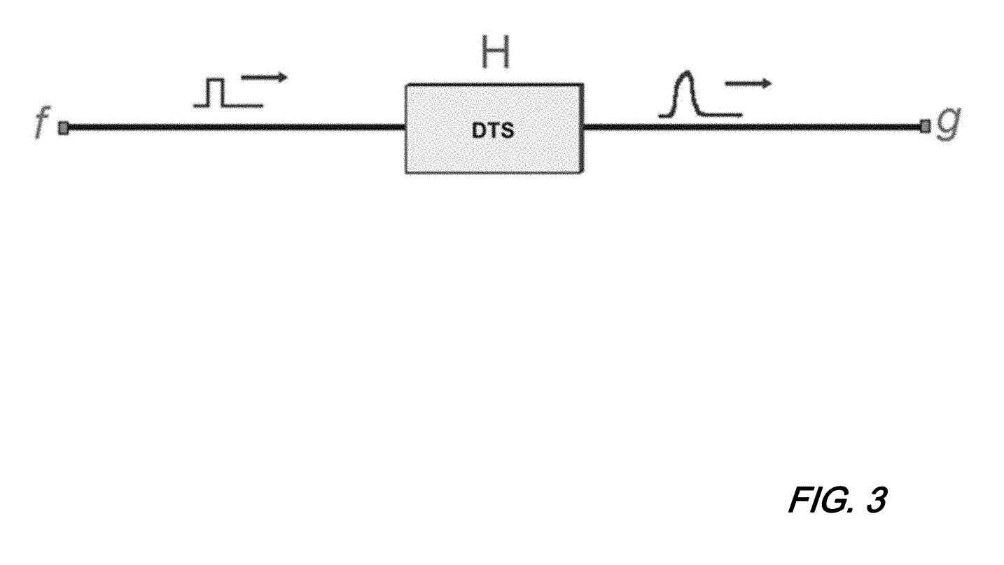

The modeling of the DTS system is based on a linear system theory, which may be understood by examination of FIG. 3. The input f(z) is the real temperature profile and the output g(z) is the DTS temperature readings/outputs. As we are considering the steady-state, i.e. no time variations, the only independent variables z which represents the distance along the optical fiber sensor. Considering the DTS as a LTI (Linear Time-Invariant) system, the response g(z) is obtained by the convolution of the DTS impulse response h(z) with input f(z),

g(z)=h(z)*f(z) (1)

Since we only need to recover the signal on what we measured, we can just consider the sampling points in the measurement, thus the discretized DTS is used rather than the continuous system.

As will be understood by those skilled in the art, convolution is a linear operation, therefore it can be expressed using a matrix-vector notation, and thus the DTS system is represented as:

$$\begin{matrix}g = Hf & ( 2 ) \\ [ \begin{matrix}g ( {z}_{1} ) \\ ⋮ \\ ⋮ \\ g ( {z}_{n} )\end{matrix} ] = [ \begin{matrix}h ( {z}_{0} ) & h ( {z}_{1} ) & … & h ( {z}_{- n + 1} ) \\ ⋮ & h ( {z}_{0} ) & … & ⋮ \\ ⋮ & ⋮ & ⋱ & ⋮ \\ h ( {z}_{n - 1} ) & … & … & h ( {z}_{0} )\end{matrix} ] [ \begin{matrix}f ( {z}_{1} ) \\ ⋮ \\ ⋮ \\ f ( {z}_{n} )\end{matrix} ] & ( 3 )\end{matrix}$$

where g is a vector formed by the sensor data (DTS readings), H is the sensitivity matrix, assembled from the DTS impulse response, f is a vector representing the actual temperature profile.

Now, we need to solve an optimization problem defined by:

min_{H}∥−Hf∥₂ (4)
subject to H is Toeplitz

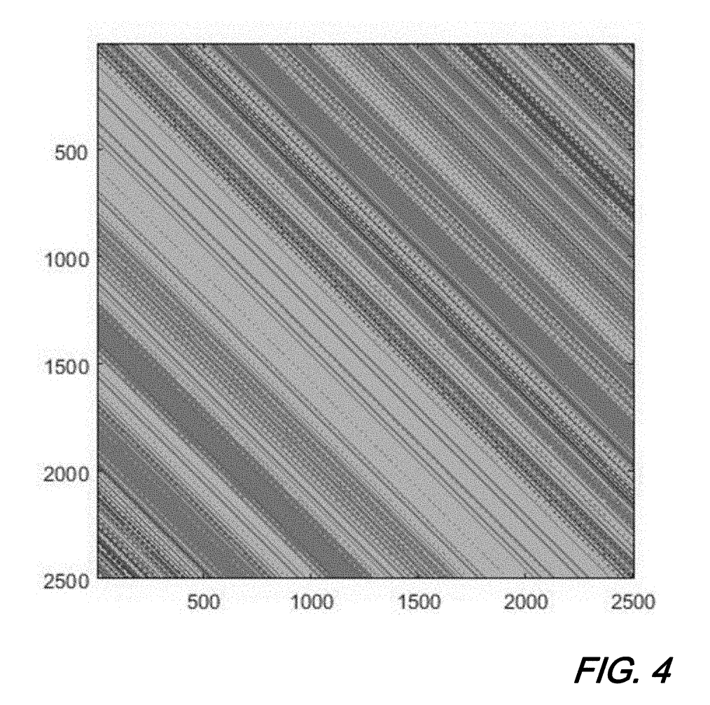

Noticing the diagonal-constant structure of matrixH, see FIG. 4, we can simplify the problem by just storing the 2n−1 unique elements of H as:

h=[hₙ₋₁, . . . ,h₁,h₀,h₋₁, . . . ,h₋ₙ₊₁]^{T} (5)

and rewrite the program as

minₕ∥g−Fh∥₂ (6)

where

$$F = {[ \begin{matrix}0 & … & 0 & {f}^{T} \\ 0 & … & {f}^{T} & 0 \\ … & … & … & … \\ {f}^{T} & 0 & … & 0\end{matrix} ]}_{n \times ( 2 n - 1 )} \qquad ( 7 )$$

Then this is just a least-squares problem, a closed-form solution could be given by:

ĥ=(F^{T}F)⁻¹F^{T}g. (8)

The system is characterized by H, so H should be as robust as possible, and the error ∥g−Hf∥₂ should be minimized when H is applied to different input signal f. This is like the training process in machine learning, the more training data g we have, the more training data g we have, the more generalized H would be, and then the matrix H will be more applicable to approximate the system in different cases. For each measurement g, we'd like to minimize ∥g−Hf∥₂, after measurement of m signals g₁, g₂, . . . , gₘ, the objective function we want to minimize is Σᵢ₌₁^{m}∥gᵢ−Fᵢh∥. Since this is an unconstrained convex program, by considering the optimality condition

F₁^{T}(F₁h−g₁)+ . . . +Fₘ^{T}(Fₘh−gₘ)=0 (9)

and following (9), we can generalize the solution as

ĥ=(Σᵢ₌₁^{m}Fᵢ^{T}Fᵢ)⁻¹(Σᵢ₌₁^{m}Fᵢ^{T}gᵢ) (10)

where fᵢ's constituting Fᵢ's are artificially generated as the recovery results corresponding to gᵢ's to train the system matrix H.

Note: The direct inverse of Σᵢ₊₁^{m}Fᵢ^{T}Fᵢ could be problematic, while iterative methods like GMRES and MINRES could be used to find approximate inverse. Here, we use GMRES in our calculation once direct inverse doesn't work.

This procedure avoids turning the system into dual (wave number/frequency) domain by Laplace transform and turning it back to primal (space/time) domain by the inverse transform. In solving the transfer function, we need to specify the number of zeros and poles, this increases the error and uncertainty by introducing these two kinds of parameters.

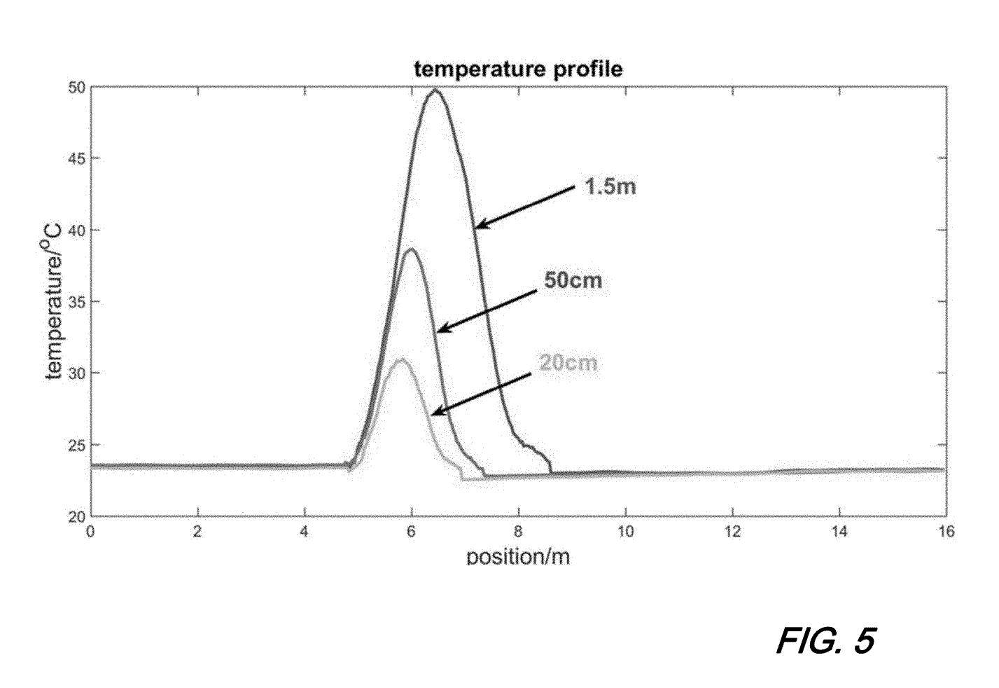

For example, we use signals with length of 20 cm, 50 cm and 1.5 m as training data, see FIG. 5, the matrix H we learnt is visualized in FIG. 4. To test whether the matrix H is good, we could compare g and Hf, where g and f are the actual temperature profile and measurement signals with length of 1 m respectively.

Algorithm 1 System Identification (see
MATLAB code SysIdentify.m and minH2.m)

Require: f₁, ... , fₘ and g₁, ... , gₘ

• Generate Fi like (7) using fi, for i = 1,. . . , m
• Compute h = (Σᵢ₌₁^{m} Fᵢ^{T} Fᵢ)⁻¹(Σᵢ₌₁^{m} Fᵢ^{T} gᵢ) by direct inverse or
GMRES
• Generate H like (3) using h

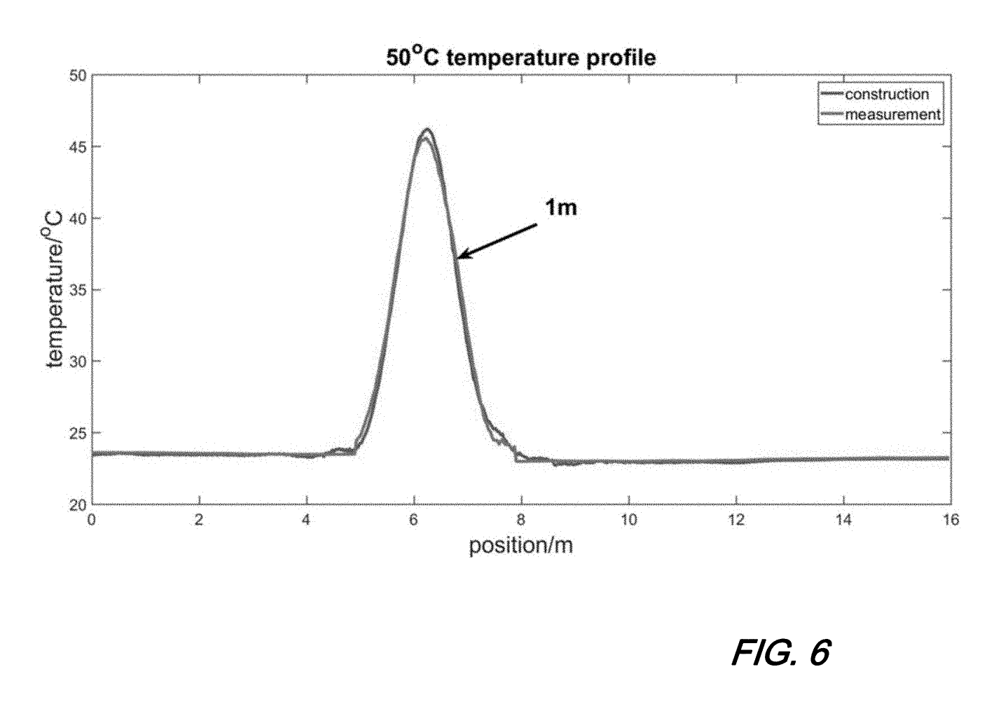

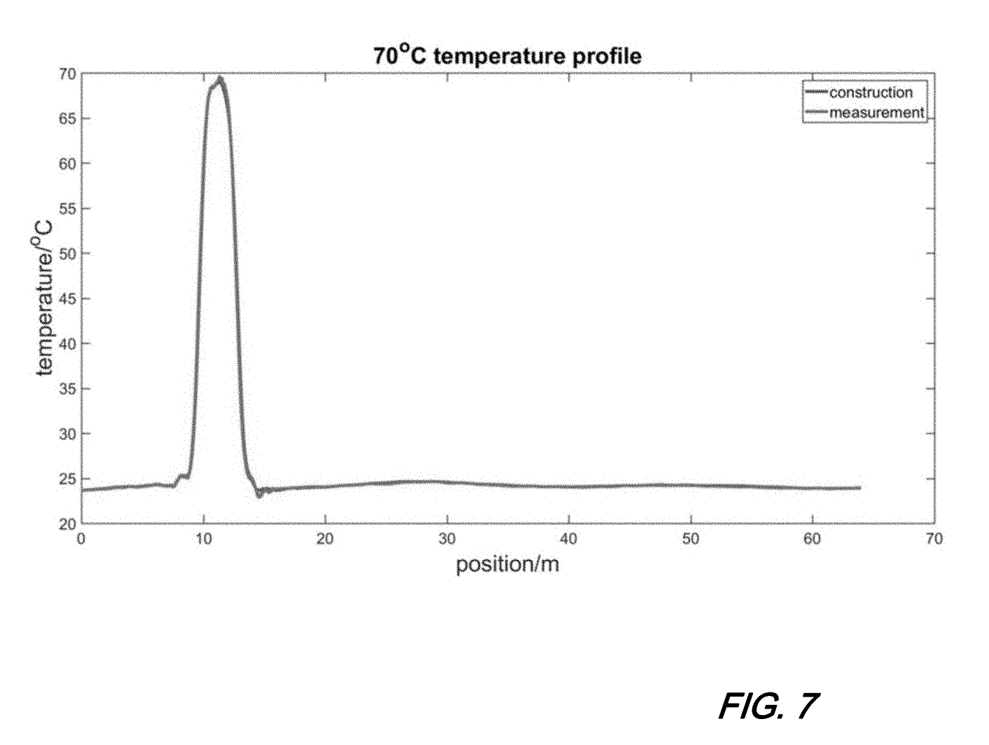

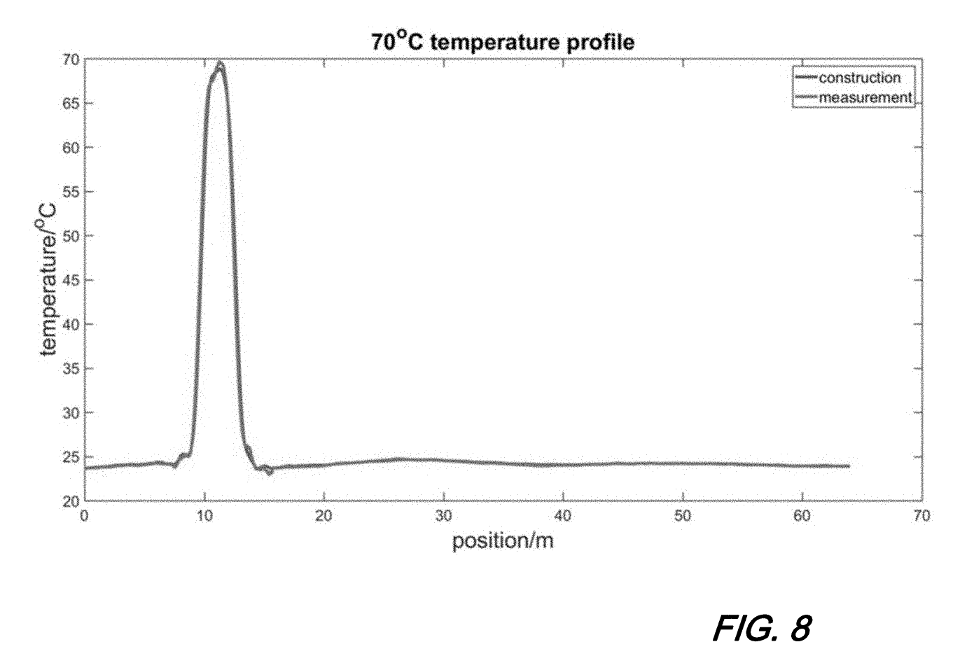

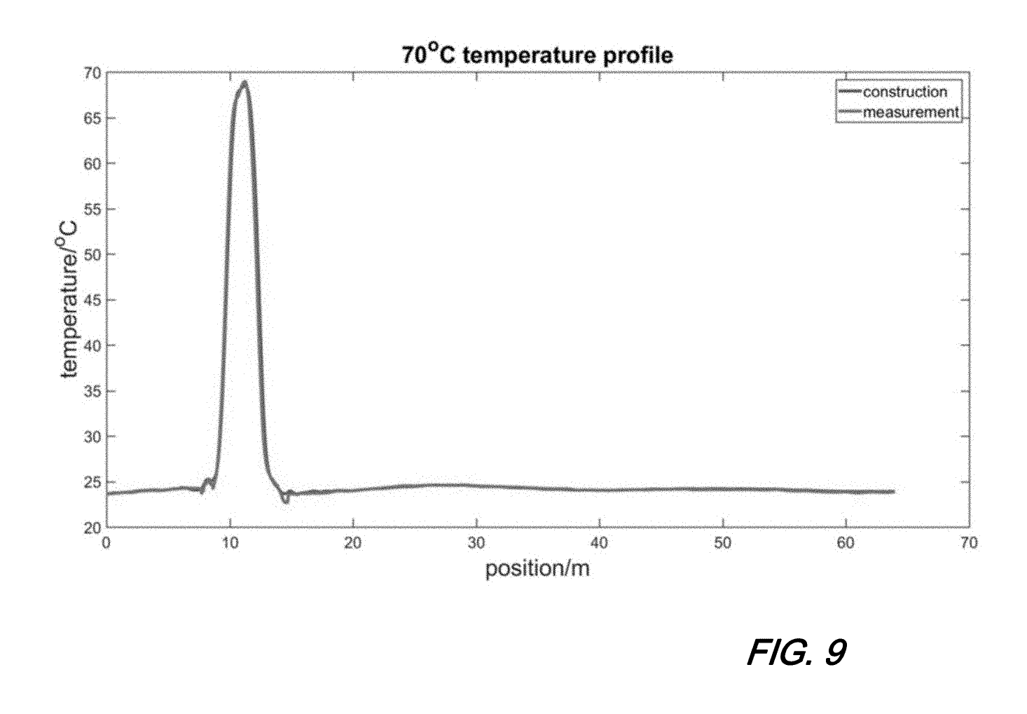

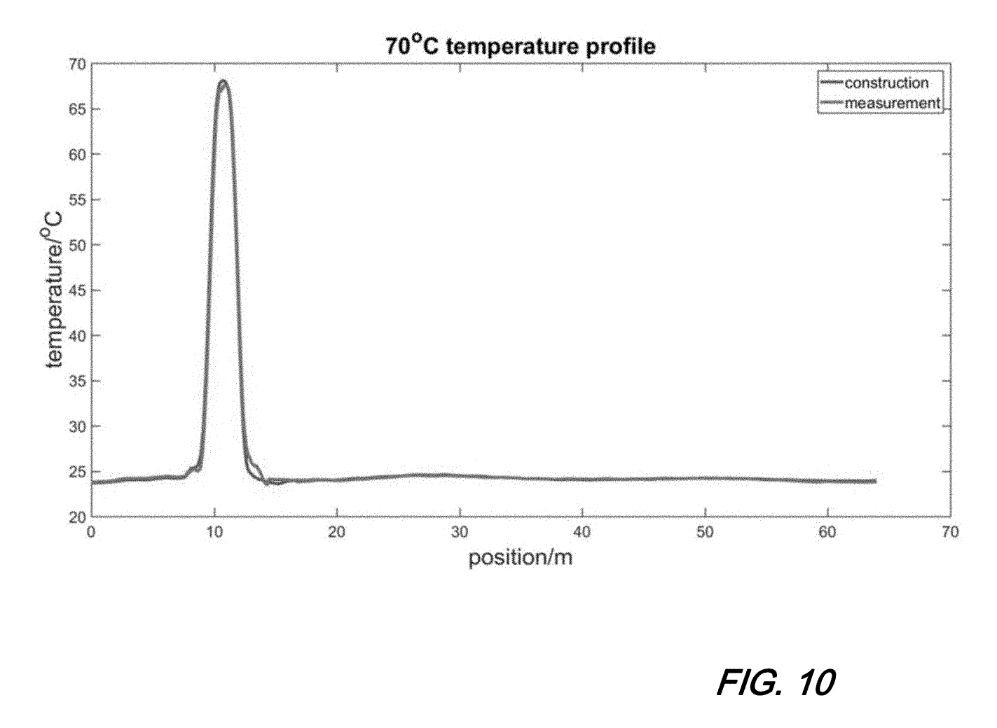

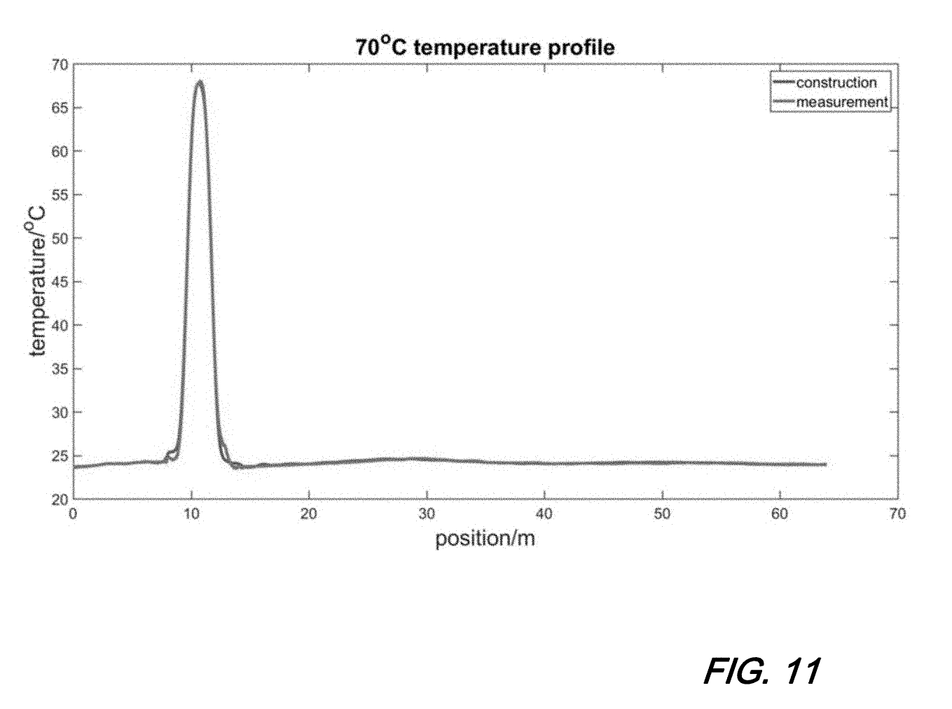

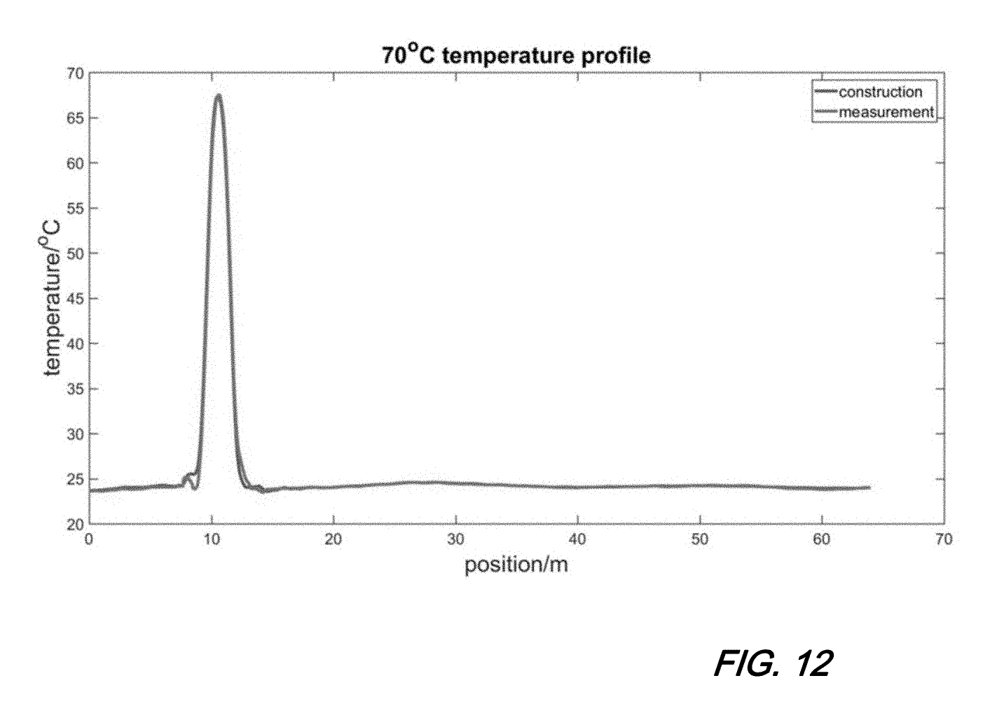

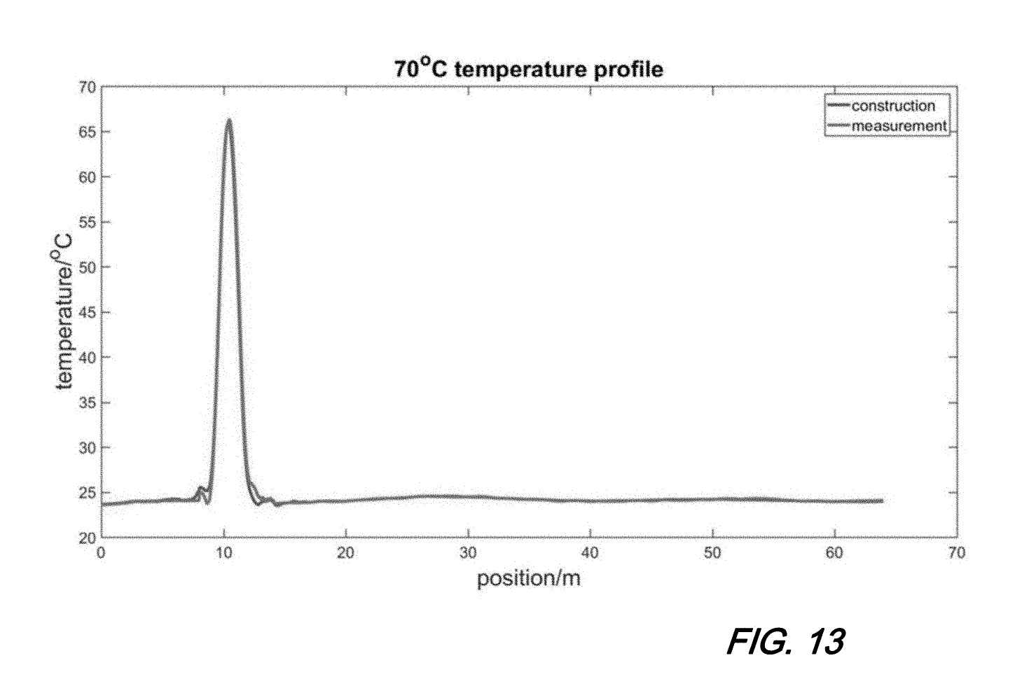

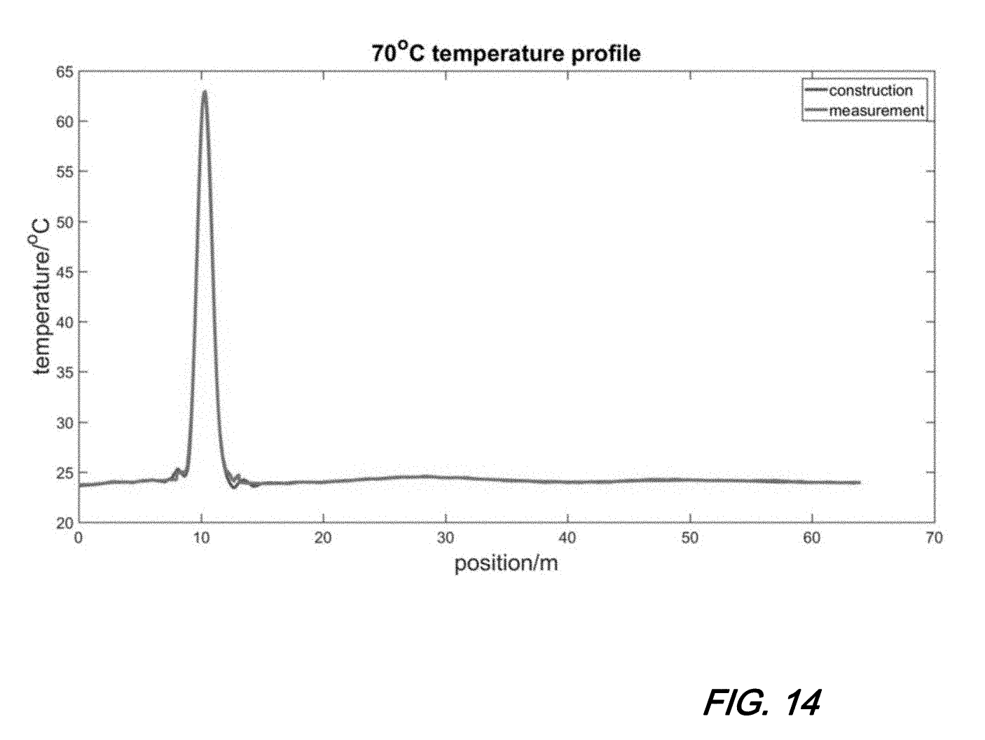

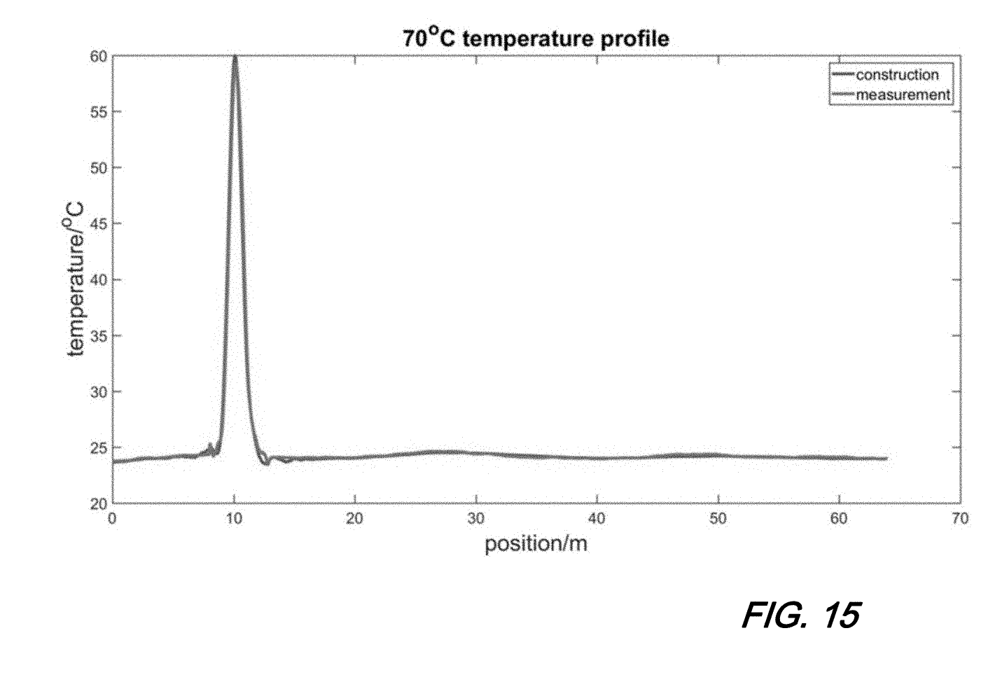

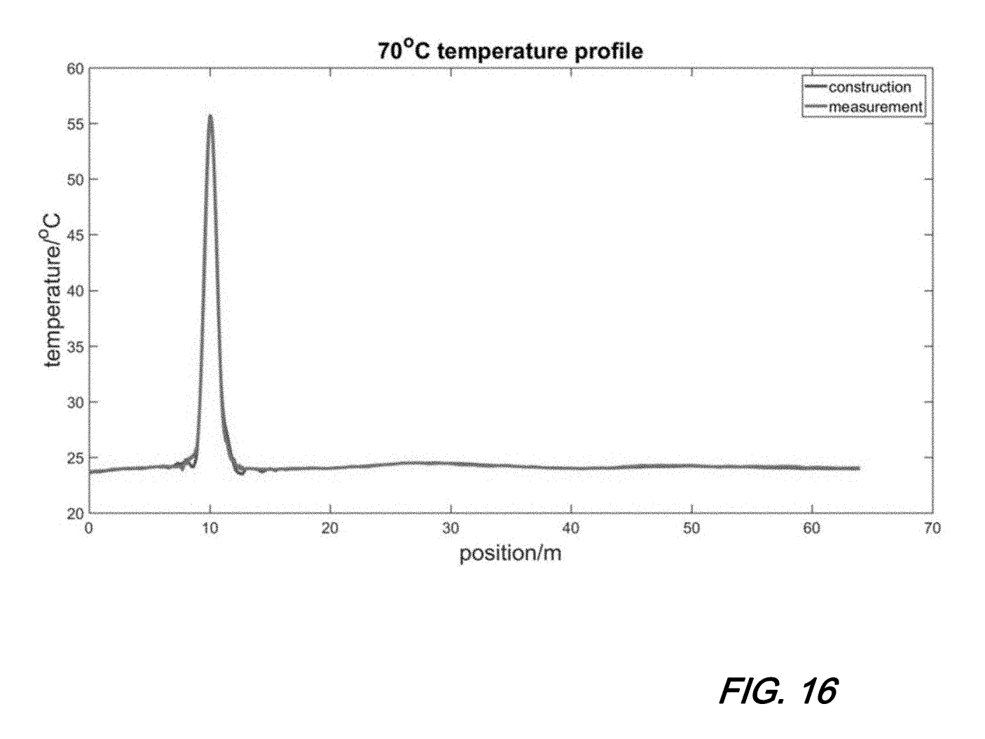

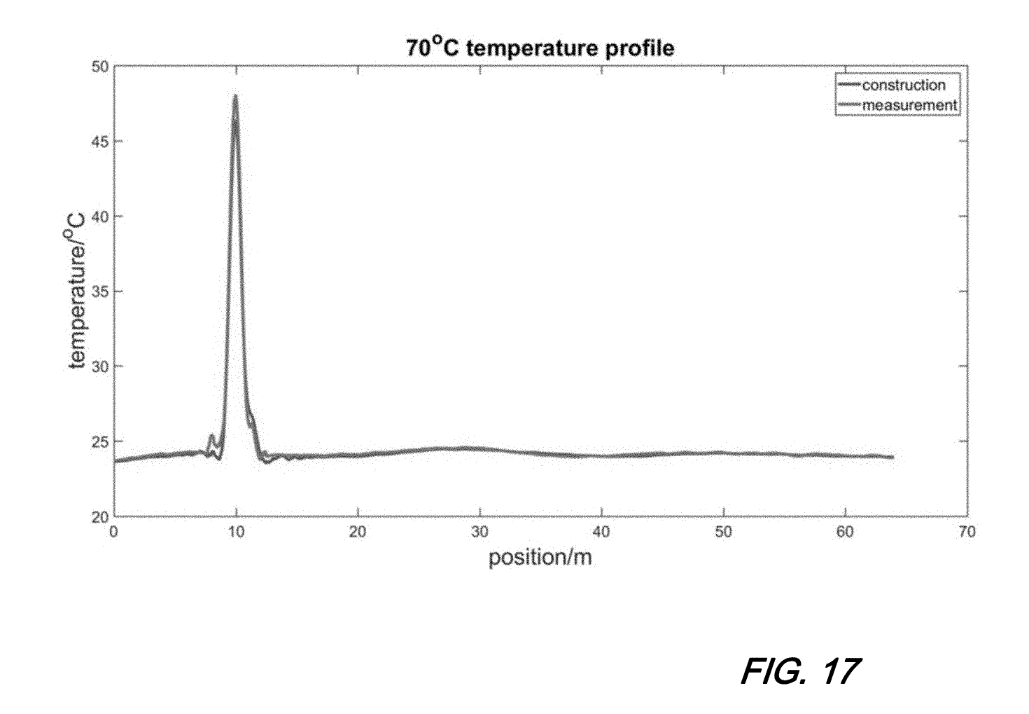

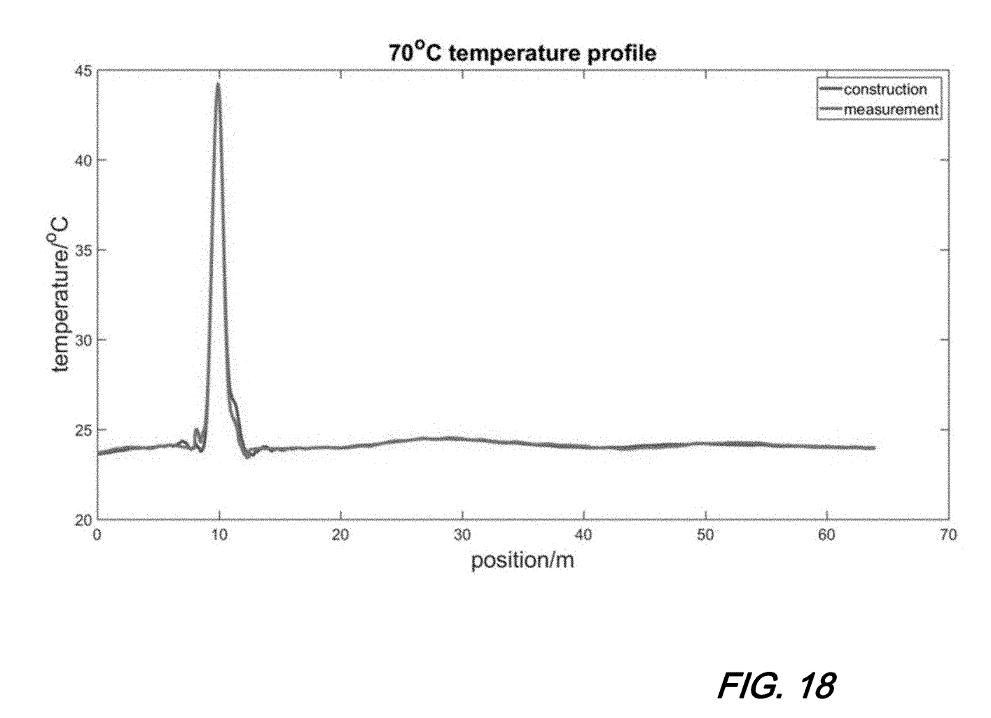

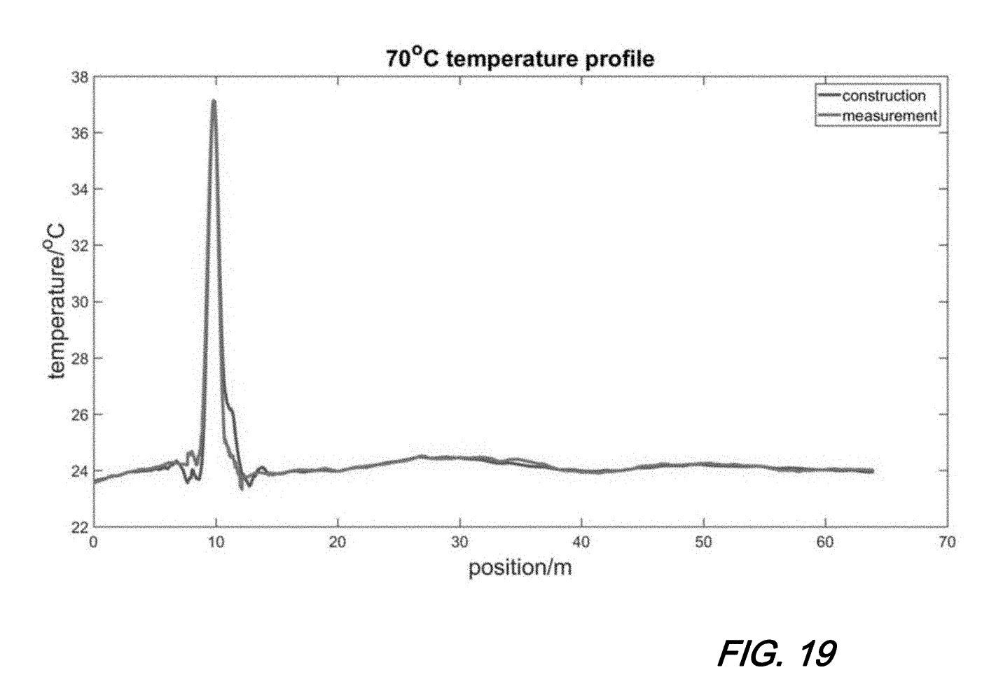

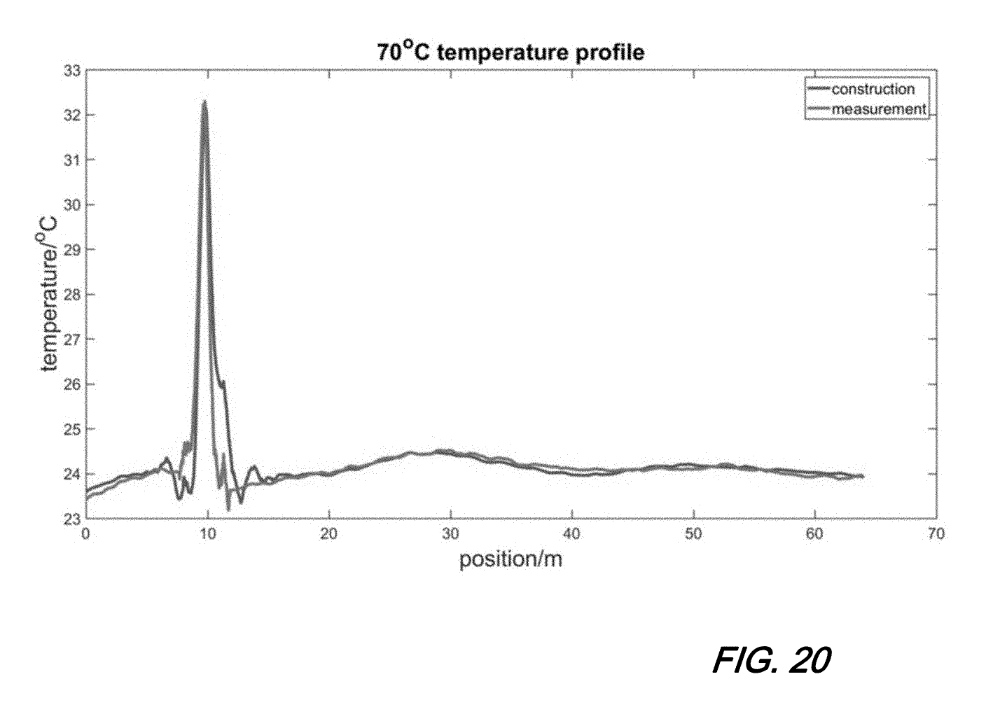

In the following, FIGS. 6-20 show test results of temperature profile at 70° C. with 14 different lengths. The system matrix H is trained by 7 out of those 14 signals. More particularly, FIG. 6 is a temperature profile plot at 50° C. of temperature ° C. vs. position/m for a 3 m construction according to aspects of the present disclosure; FIG. 7 is a temperature profile plot at 70° C. of temperature ° C. vs. position/m for a 3 m construction according to aspects of the present disclosure; FIG. 8 is a temperature profile plot at 70° C. of temperature ° C. vs. position/m for a 2.8 m construction according to aspects of the present disclosure; FIG. 9 is a temperature profile plot at 70° C. of temperature ° C. vs. position/m for a 2.5 m construction according to aspects of the present disclosure; FIG. 10 is a temperature profile plot at 70° C. of temperature ° C. vs. position/m for a 2.2 m construction according to aspects of the present disclosure; FIG. 11 is a temperature profile plot at 70° C. of temperature ° C. vs. position/m for a 2 m construction according to aspects of the present disclosure; FIG. 12 is a temperature profile plot at 70° C. of temperature ° C. vs. position/m for a 1.8 m construction according to aspects of the present disclosure; FIG. 13 is a temperature profile plot at 70° C. of temperature ° C. vs. position/m for a 1.5 m construction according to aspects of the present disclosure; FIG. 14 is a temperature profile plot at 70° C. of temperature ° C. vs. position/m for a 1.2 m construction according to aspects of the present disclosure; FIG. 15 is a temperature profile plot at 70° C. of temperature ° C. vs. position/m for a 1 m construction according to aspects of the present disclosure; FIG. 16 is a temperature profile plot at 70° C. of temperature ° C. vs. position/m for a 80 cm construction according to aspects of the present disclosure; FIG. 17 is a temperature profile plot at 70° C. of temperature ° C. vs. position/m for a 50 cm construction according to aspects of the present disclosure; FIG. 18 is a temperature profile plot at 70° C. of temperature ° C. vs. position/m for a 40 cm construction according to aspects of the present disclosure; FIG. 19 is a temperature profile plot at 70° C. of temperature ° C. vs. position/m for a 20 cm construction according to aspects of the present disclosure; and FIG. 20 is a temperature profile plot at 70° C. of temperature ° C. vs. position/m for a 10 m construction according to aspects of the present disclosure.

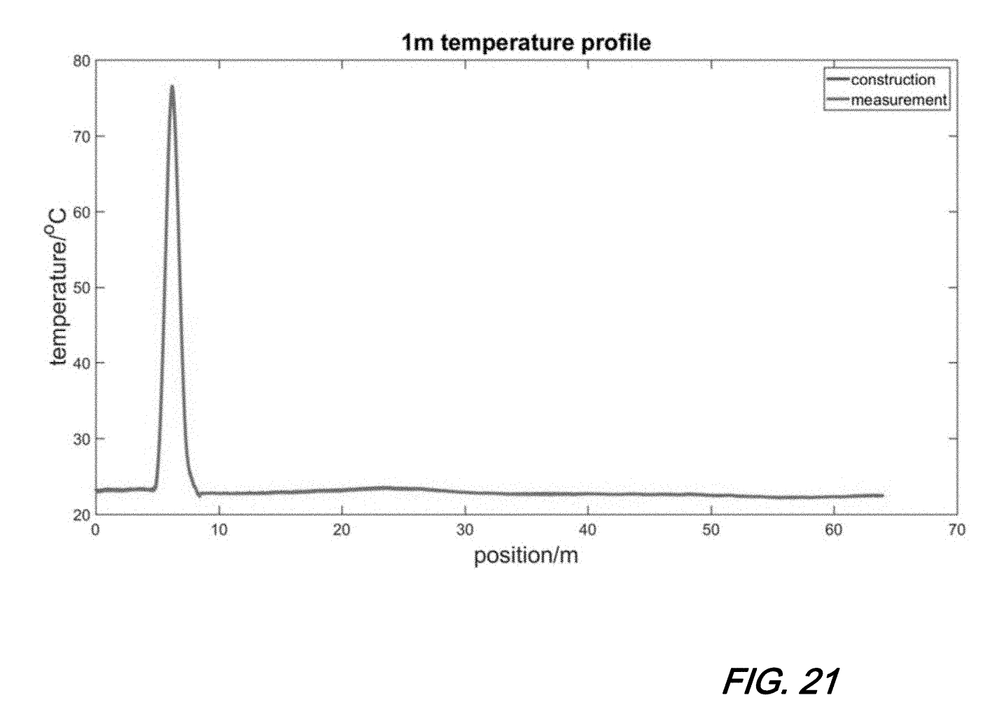

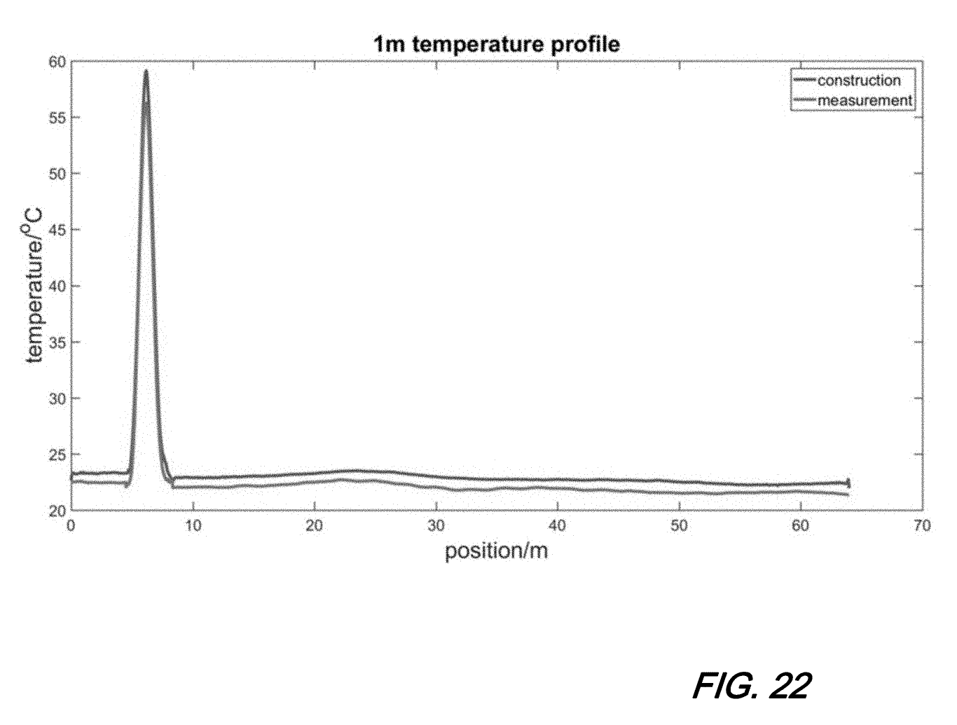

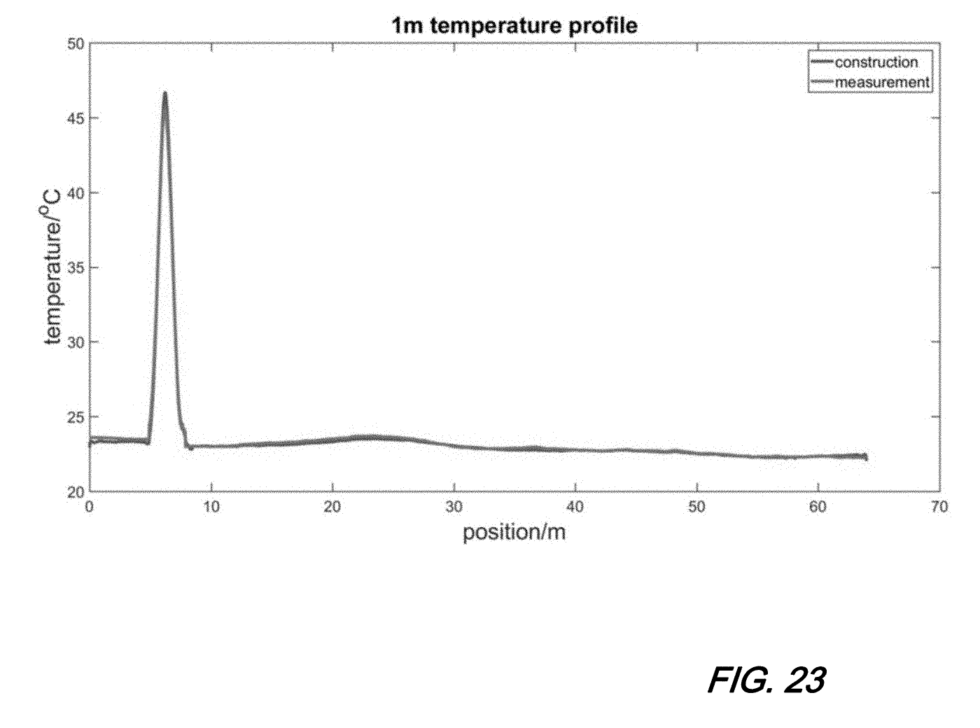

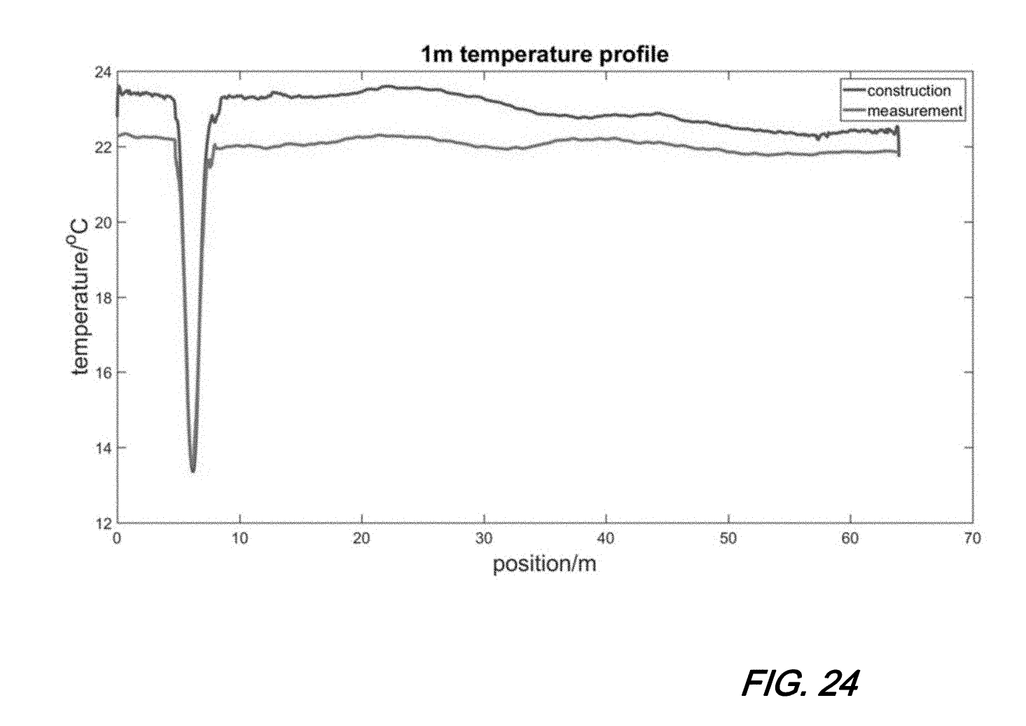

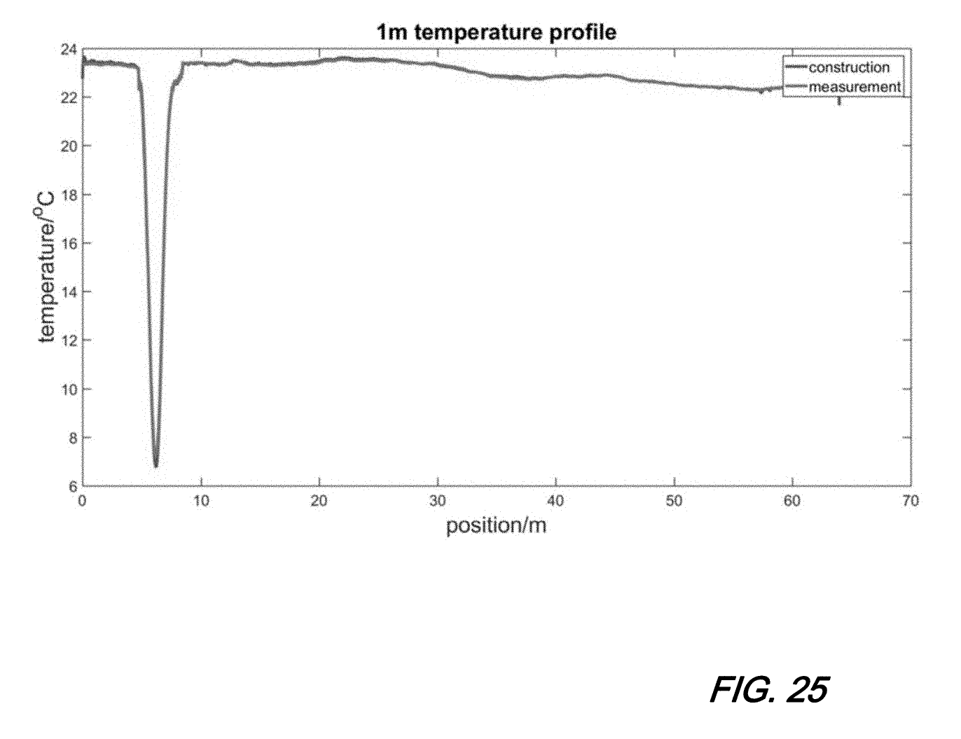

In FIGS. 21-25 we show test results of temperature profile with 1 m at different lengths. The system matrix H is trained by 3 out of those 5 signals. In particular, FIG. 21 is a 1 m temperature profile plot of temperature ° C. vs. position/m for an 85° C. construction according to aspects of the present disclosure; FIG. 22 is a 1 m temperature profile plot of temperature ° C. vs. position/m for a 65° C. construction according to aspects of the present disclosure; FIG. 23 is a 1 m temperature profile plot of temperature ° C. vs. position/m for a 50° C. construction according to aspects of the present disclosure; FIG. 24 is a 1 m temperature profile plot of temperature ° C. vs. position/m for a 10° C. construction according to aspects of the present disclosure; and FIG. 25 is a 1 m temperature profile plot of temperature ° C. vs. position/m for a 2.1° C. construction according to aspects of the present disclosure.

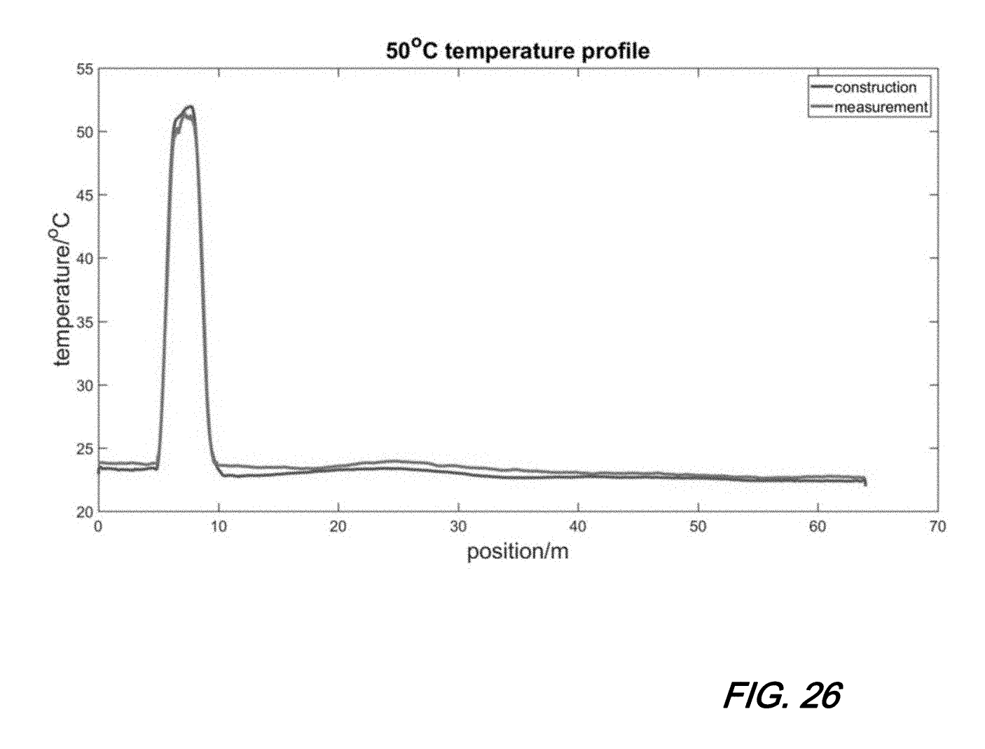

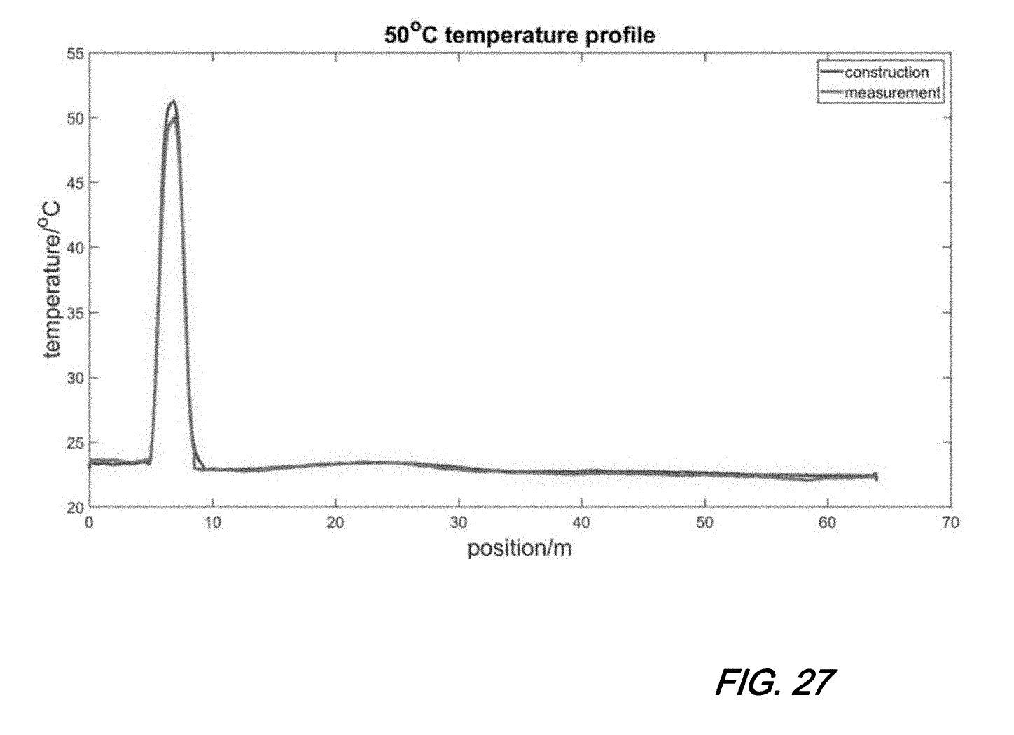

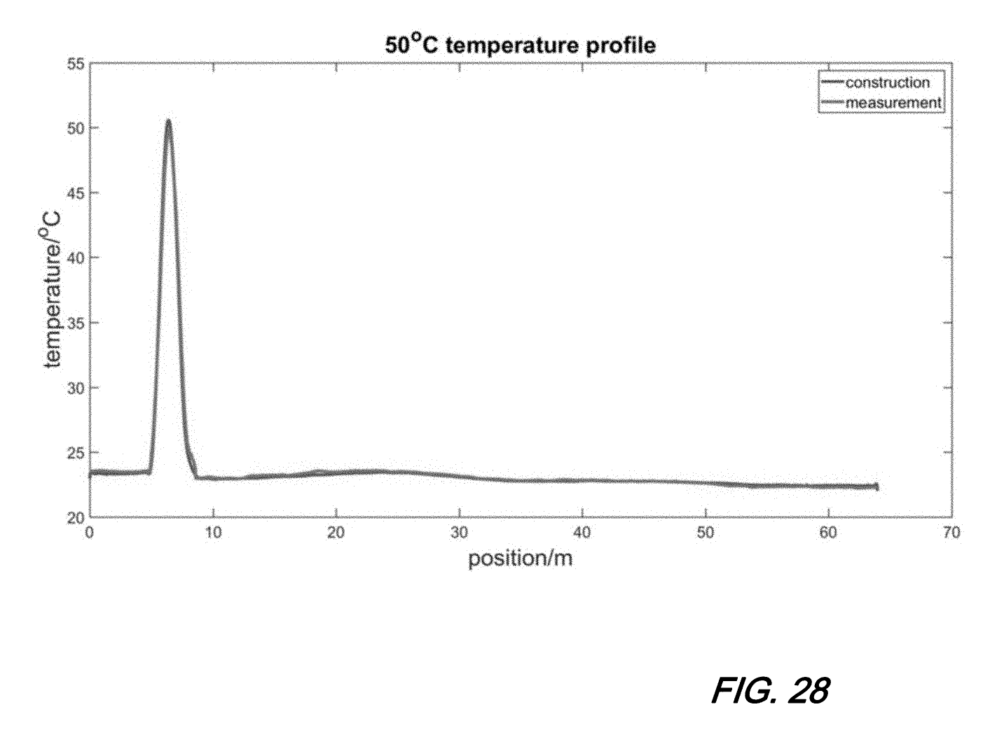

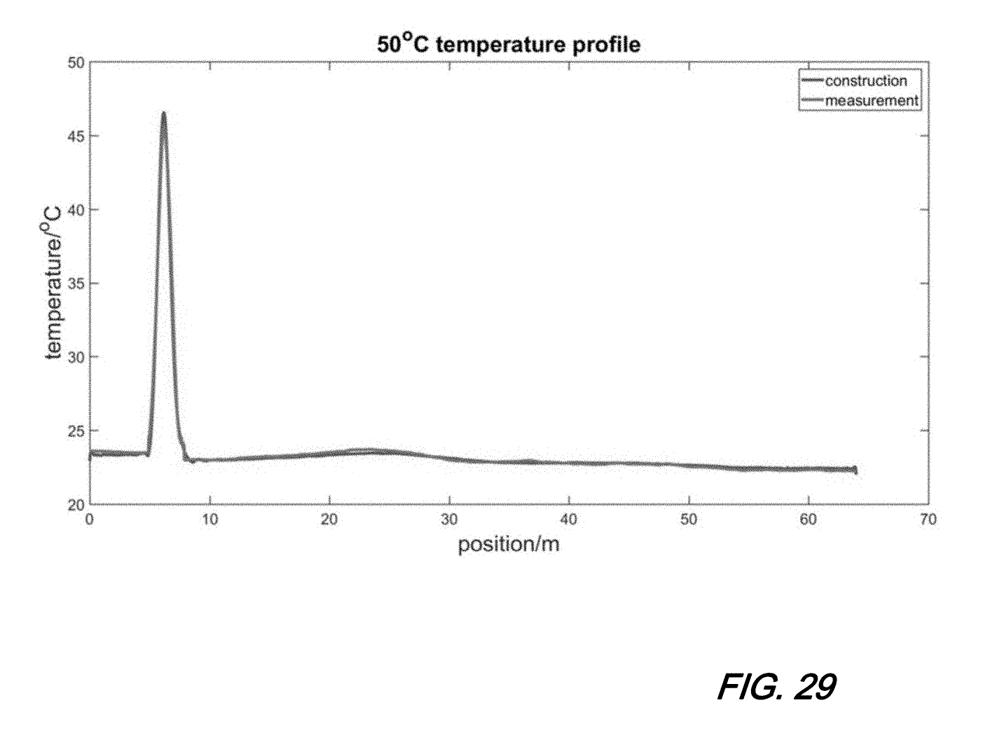

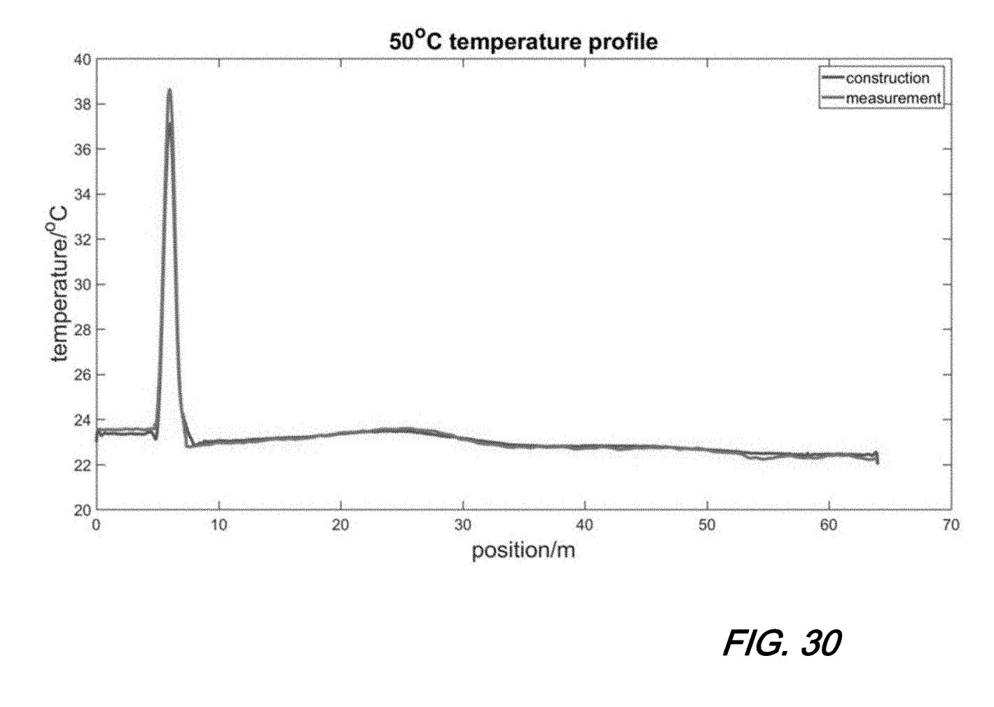

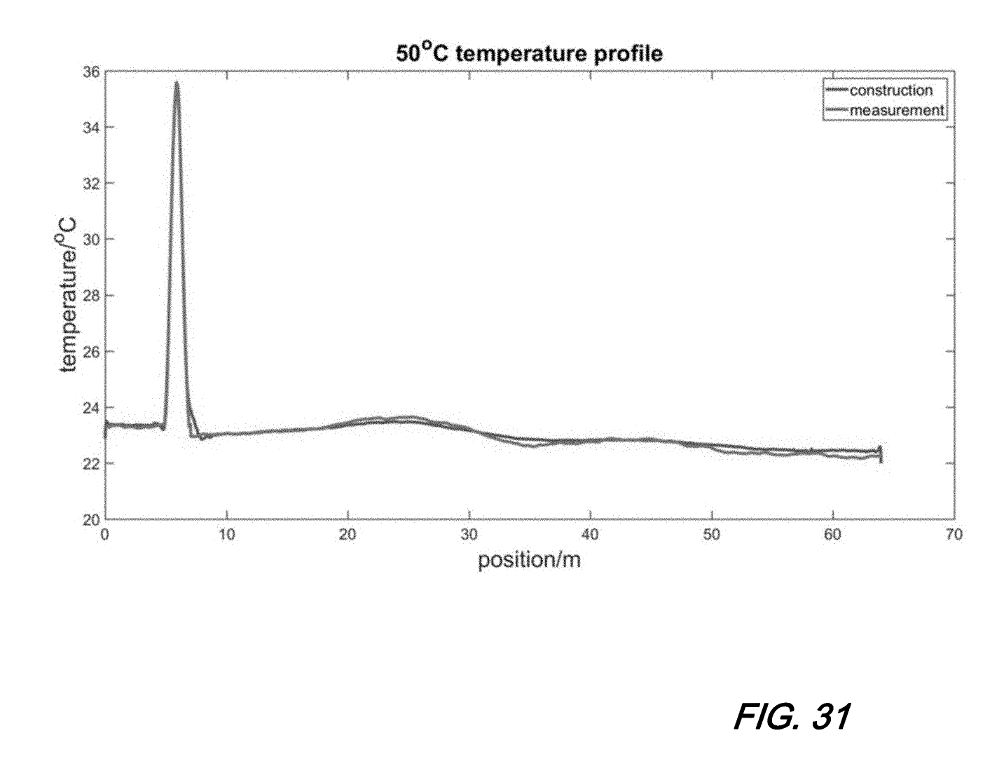

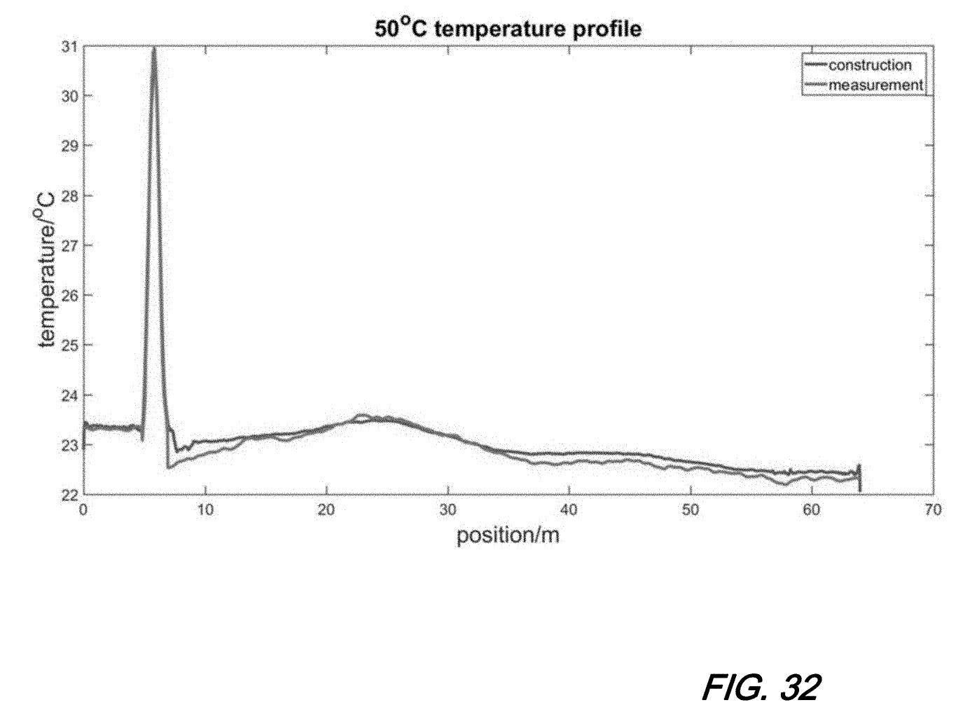

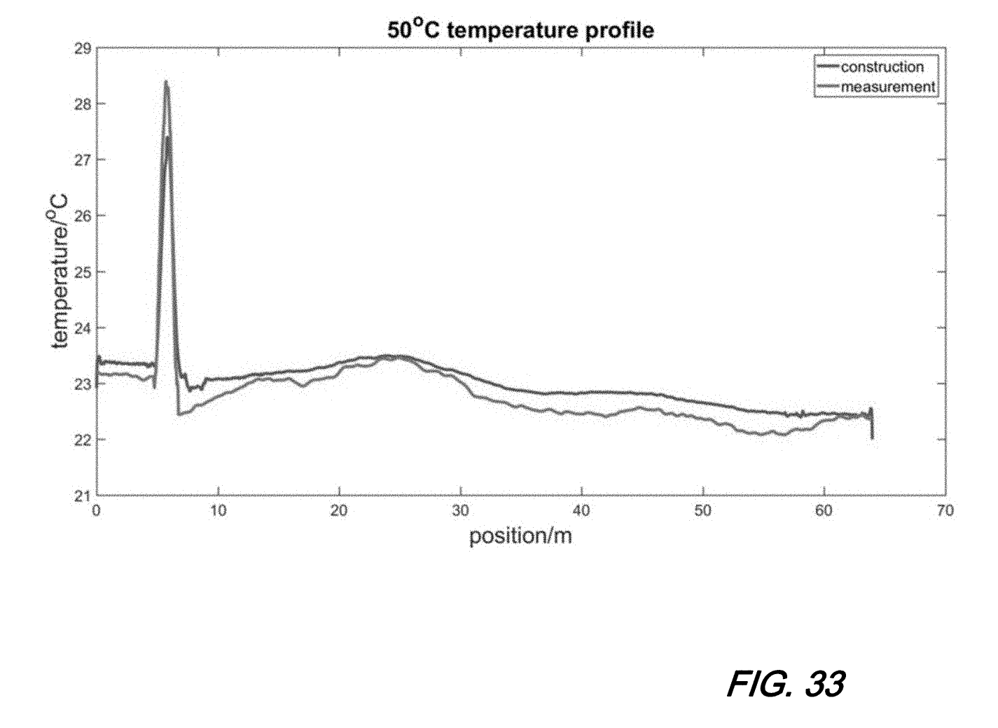

FIGS. 26-33 show test results of temperature profile at 50° C. with 8 different lengths. The system matrix H is trained by 9 signals with length of 20 cm, 50 cm and 1.5 m, and at 2.1° C., 50° C. and 85° C. In particular, FIG. 26 is a 50° C. temperature profile plot of temperature ° C. vs. position/m for a 2 m construction according to aspects of the present disclosure; FIG. 27 is a 50° C. temperature profile plot of temperature ° C. vs. position/m for a 2 m construction according to aspects of the present disclosure; FIG. 28 is a 50° C. temperature profile plot of temperature ° C. vs. position/m for a 1.5 m construction according to aspects of the present disclosure; FIG. 29 is a 50° C. temperature profile plot of temperature ° C. vs. position/m for a 1 m construction according to aspects of the present disclosure; FIG. 30 is a 50° C. temperature profile plot of temperature ° C. vs. position/m for a 50 cm construction according to aspects of the present disclosure; FIG. 31 is a 50° C. temperature profile plot of temperature ° C. vs. position/m for a 40 cm construction according to aspects of the present disclosure; FIG. 32 is a 50° C. temperature profile plot of temperature ° C. vs. position/m for a 20 cm construction according to aspects of the present disclosure; and FIG. 33 is a 50° C. temperature profile plot of temperature ° C. vs. position/m for a 10 cm construction according to aspects of the present disclosure.

### Signal Recovery

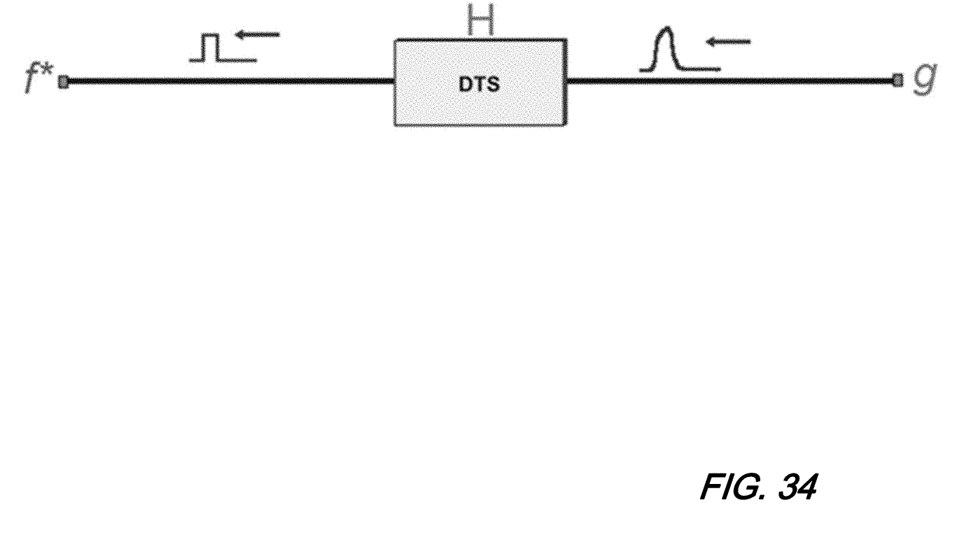

FIG. 34 is a schematic diagram illustrating signal recovery according to aspects of the present disclosure. After the training process, we have learned H using training data g₁, g₂, . . . , gₘ and input signals f₁, f₂, . . . , fₘ. Now we'd like reverse the process, see FIG. 7. Given a measurement signal g, we want to recover the input signal f corresponding to g using H. This is regression, an inverse problem, basically we need to solve “g=H⁻¹ f”, which requires regularization to avoid over-fitting, stabilize the reconstruction and improve the results. As we have noted, to reconstruct piecewise constant signals, it employed a total variation penalization. The basic structure of the solution is given by

\hat{f}=argmin_{f}∥g−Hf∥₁+λ∥Df∥₁ (11)

where \hat{f} is the reconstructed signal, λ is the regularization parameter which controls the sensitivity of solution to noise, and D is a finite difference matrix

$$D = {[ \begin{matrix}- 1 & 1 & 0 & … & 0 \\ 0 & - 1 & 1 & … & 0 \\ ⋮ & … & ⋱ & ⋱ & ⋮ \\ 0 & … & 0 & - 1 & 1\end{matrix} ]}_{( n - 1 ) \times n } \qquad ( 12 )$$

To solve this program, we use Alternating Direction Method of Multipliers (ADMM), which solves this problem by splitting it into 3 sub-problems and each one is easier than the original one, then the solution is given by solving sub-problems iteratively.

We note that ADMM is a simple but powerful algorithm that is well suited to distributed convex optimization, and in particular to problems arising in applied statistics and machine learning with large datasets and high-dimensional data. It takes the form of a decomposition-coordination procedure, in which the solutions to small local subproblems are coordinated to find a solution to a large global problem. ADMM can be viewed as an attempt to blend the benefits of dual decomposition and augmented Lagrangian methods for constrained optimization. The optimization problem is solved by transforming the original unconstrained minimization problem (9) to an equivalent constrained minimization problem (13). An augmented Lagrangian method is used to handle the constraints, and an alternating direction method is used to iteratively and solutions to the subproblems.

By introducing two variables r and u, we modify the problem as an ADMM form

$${minimize}_{f , r , u} {‖ r ‖}_{1} + λ {‖ u ‖}_{1} \\ subject to r = Hf - g \\ u = Df \qquad ( 13 )$$

The augmented Lagrangian is given by

$$L ( f , r , u , y , z ) = {‖ r ‖}_{1} + λ {‖ u ‖}_{1} - {z}^{T} ( r - Hf + g ) + \frac{{ρ}_{o}}{2} {‖ r - Hf + g ‖}_{2}^{2} - {y}^{T} ( u - Df ) + \frac{{ρ}_{r}}{2} {‖ u - Df ‖}_{2}^{2} \qquad ( 14 )$$

Here, variable z is the Lagrange multiplier associated with constraint r=Hf−g, and variable y is the Lagrange multiplier associated with the constraint u=Df. Parameters ρₒ and ρᵣ are two regularization parameters. Subscripts “o” and “r” stand for objective and regularization, respectively. For each iteration, do the following steps, until convergence criteria are achieved.

ADMM Iterations

(1) u-Subproblem

$${minimize}_{f} \frac{{ρ}_{o}}{2} {‖ r - Hf + g ‖}_{2}^{2} + \frac{{ρ}_{r}}{2} {‖ u - Df ‖}_{2}^{2} + {z}^{T} Hf + {y}^{T} Df \qquad ( 15 )$$

Optimality condition gives

−ρₒH^{T}(r−Hf+g)−ρᵣD^{T}(u−Df)+H^{T}z+D^{T}y=0 (16)

then f-update is

$${f}_{k + 1} = {( {ρ}_{o} {H}^{T} H + {ρ}_{r} {W}^{T} W )}^{- 1} {ρ}_{o} {H}^{T} g + {ρ}_{o} {H}^{T} ( {r}_{k} - {\overline{z}}_{k} ) + {ρ}_{r} {D}^{T} ( {u}_{k} - {\overline{y}}_{k} ) \\ where {\overline{z}}_{k} = \frac{1}{{ρ}_{o}} {z}_{k} and {\overline{y}}_{k} = \frac{1}{{ρ}_{r}} {y}_{k} . \qquad ( 17 )$$

(2) u-Subproblem

$${minimize}_{u} λ {‖ u ‖}_{1} - {y}^{T} u + \frac{{ρ}_{r}}{2} {‖ u - Df ‖}_{2}^{2} \qquad ( 18 )$$

u-update is

uₖ₊₁=T_{λ/ρ}_{ᵣ}(D fₖ₊₁+y̅ₖ) (19)

where T_{λ}(⋅) is the term-by-term soft-thresholding operator

$${T}_{λ} ( v ) [ n ] = \{ \begin{matrix}v [ n ] - λ , & v [ n ] > λ \\ 0 , & \vert v [ n ] \vert \leq λ \\ v [ n ] + λ , & v [ n ] < - λ\end{matrix} \qquad ( 20 )$$

(3) r-Subproblem

$${minimize}_{r} {‖ r ‖}_{1} - {z}^{T} r + \frac{{ρ}_{o}}{2} {‖ r - Hf + g ‖}_{2}^{2} \qquad ( 21 )$$

r-update is

rₖ₊₁=T_{1/ρ}_{ₒ}(Hfₖ₊₁−g+z̅ₖ̅) (22)

(4) y-Update and z-Update

y̅ₖ₊₁=y̅ₖ−(uₖ₊₁−Dfₖ₊₁) (23)

z̅ₖ₊₁=z̅ₖ−(rₖ₊₁−Hfₖ₊₁+g) (24)

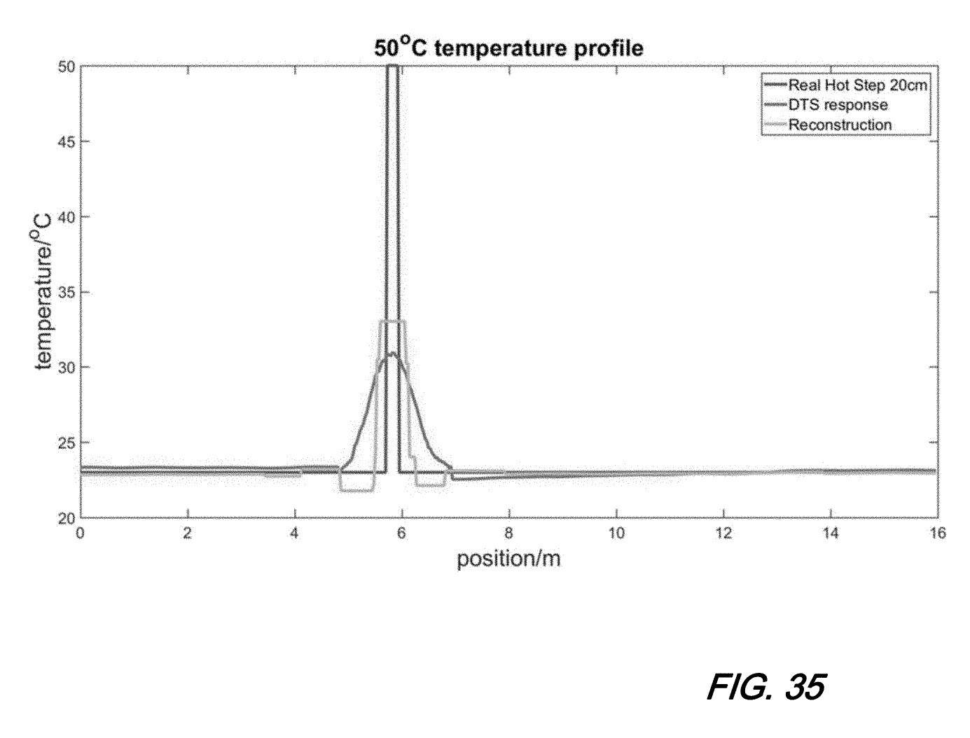

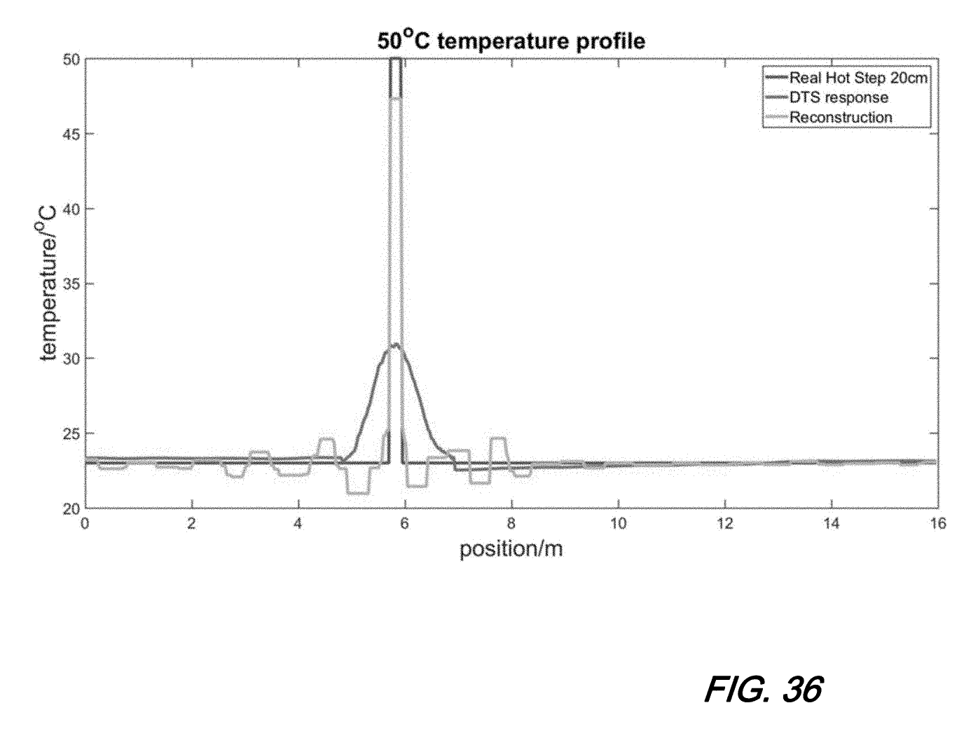

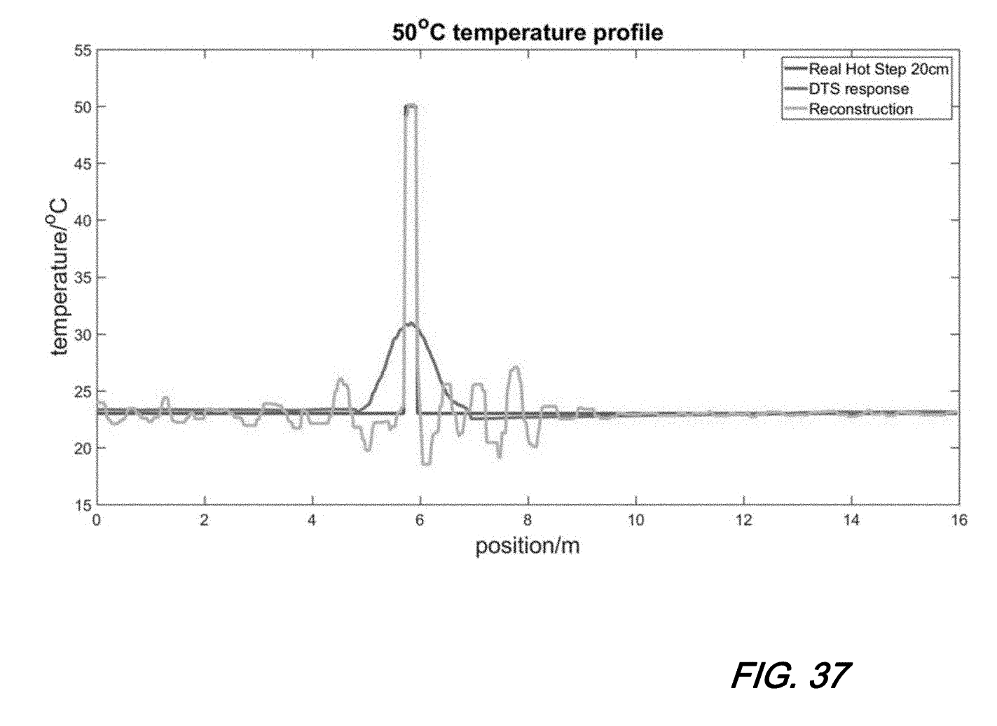

FIG. 35 is a 50° C. temperature profile plot of temperature ° C. vs. position/m for a 20 cm λ=1 construction according to aspects of the present disclosure. FIG. 36 is a 50° C. temperature profile plot of temperature ° C. vs. position/m for a 20 cm λ=0.1 construction according to aspects of the present disclosure. FIG. 37 is a 50° C. temperature profile plot of temperature ° C. vs. position/m for a 20 cm λ=0.02 construction according to aspects of the present disclosure.

These recovery results show that when the coil is short, we need a small parameter λ to make the highest temperature in reconstructed signal to be accurate, but this will introduce a lot of noise to the reconstruction signal. Since λ controls the difference between two adjacent points f_{i±1}−fᵢ, i.e. the increment at each point, when λ is small, it allows a huge increment at each point, including both the area of interests and other regions at room temperature. Therefore, λ=0.02 helps increase the highest temperature and gives a better recovery at the hot region in FIG. 8, but as a byproduct, it will also introduce noise at other places, e.g., see FIG. 10.

We believe this results from that we use a uniform λ to control the increment everywhere along the fiber. If a varying λ is used, this problem might be solved. Thus, we put different weights on elements of f according to their values in g as follows:

For room temperature (assuming to be 23° C.), the weight is U, for maximum in g, the weight is L, and for other value t, a linear interpolation is used to give a weight w

$$w = \frac{t - max g}{23 - max g} ( U - L ) + L \qquad ( 25 )$$

Then matrix D is rewritten into a weighted version

$$D = {[ \begin{matrix}- {w}_{1} & {w}_{1} & 0 & … & 0 \\ 0 & - {w}_{2} & {w}_{2} & … & 0 \\ ⋮ & … & ⋱ & ⋱ & ⋮ \\ 0 & … & 0 & - {w}_{n - 1} & {w}_{n - 1}\end{matrix} ]}_{( n - 1 ) \times n} \qquad ( 26 )$$

Solving the weighted total variation problem

\hat{f}=argmin_{f}∥g−Hf∥₁+λ∥Wf∥₁ (27)

gives the reconstruction \hat{f}. Detailed recovery algorithm is shown in Algorithm 2.

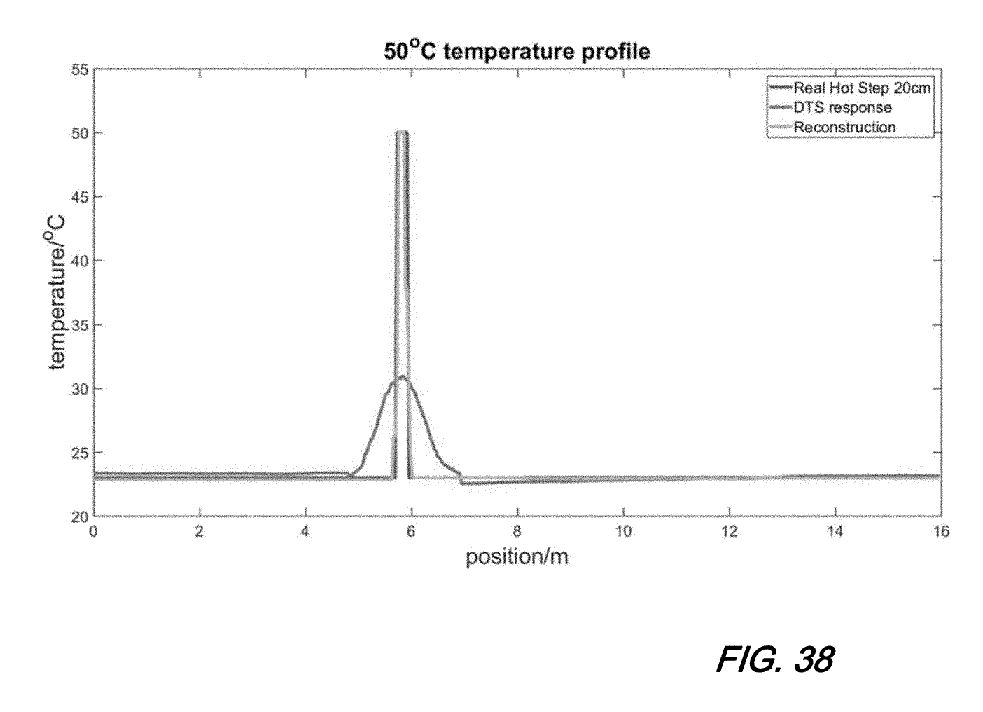

FIG. 38 is a 50° C. temperature profile plot of temperature ° C. vs. position/m for a weighted total variation according to aspects of the present disclosure.

Algorithm 2 Signal recovery (see MATLAB code tv_deconvolution.m)

Require: g

[symbol]

signal to recover

Require: H [symbol]
system matrix
Require: D [symbol]
finite difference matrix

| | |
|---|---|
| Require: λ | [symbol] |

regularization parameter

| | |
|---|---|
| Require: L | [symbol] |

lower bound on weights

| | |
|---|---|
| Require: U | [symbol] |

upper bound on weights

1. Compute weighted finite difference matrix B using D, L and U

• Follow (23) and (24)

2. Solve (25) by ADMM
In each iteration

• f −update

fₖ₊₁ = (ρₒH^{T}H + ρᵣW^{T}W)⁻¹ρₒH^{T}g + ρₒH^{T}(rₖ − z̅ₖ) + ρᵣD^{T}(uₖ − y̅ₖ)

(28)

• u −update

| | |
|---|---|
| uₖ₊₁ = T_{λ/ρ}_{ᵣ}(Wfₖ₊₁ + y̅ₖ) | (29) |

• r −update

| | |
|---|---|
| rₖ₊₁ = T_{1/ρ}_{ₒ}(Hfₖ₊₁ − g + z̅ₖ̅) | (30) |

• y −update and z −update

| | |
|---|---|
| y̅ₖ₊₁ = y̅ₖ − (uₖ₊₁ − Wfₖ₊₁) | (31) |
| z̅ₖ₊₁ = z̅ₖ − (rₖ₊₁ − Hfₖ₊₁ + g) | (32) |

3. Until convergence

• return f

Comparing FIG. 37 and FIG. 38, it's clear that noise is cleaned and the shape of the recovery and actual temperature profile match reasonably well. Now we have more parameters λ, L and U to tune and L is usually fixed as 1, and smaller λ and larger U will make the region of interest have a higher temperature. This will bring more flexibility and freedom for us have a good recovery, but more complexity is also introduced. Usually for fiber with length longer than 1 m, we could use λ=5, L=1 and U=5. More detailed parameter tuning process will be discussed later in this disclosure.

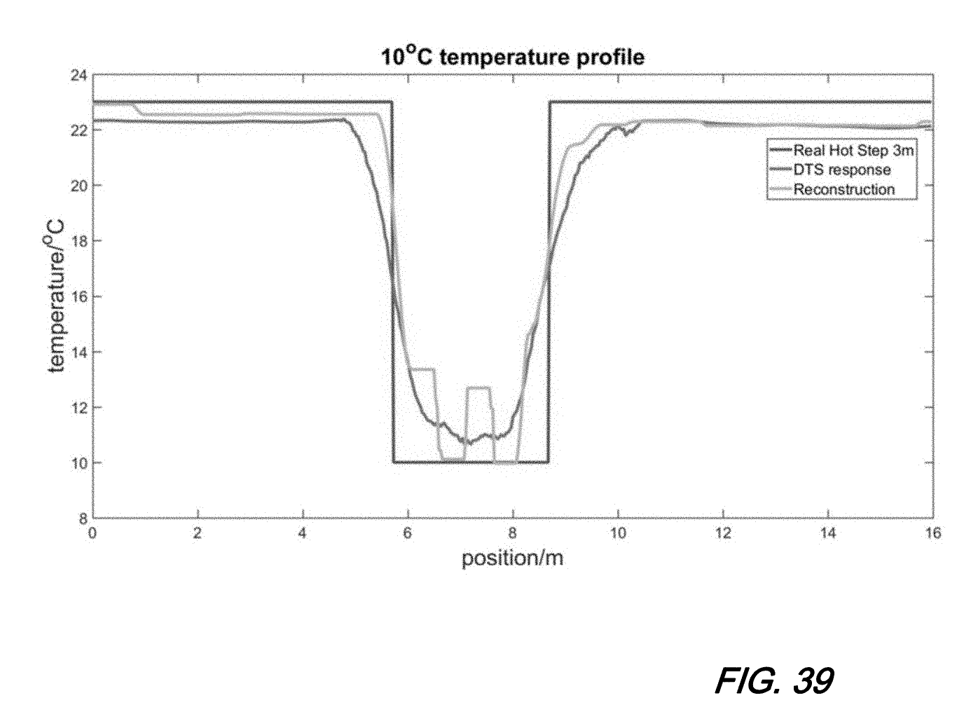

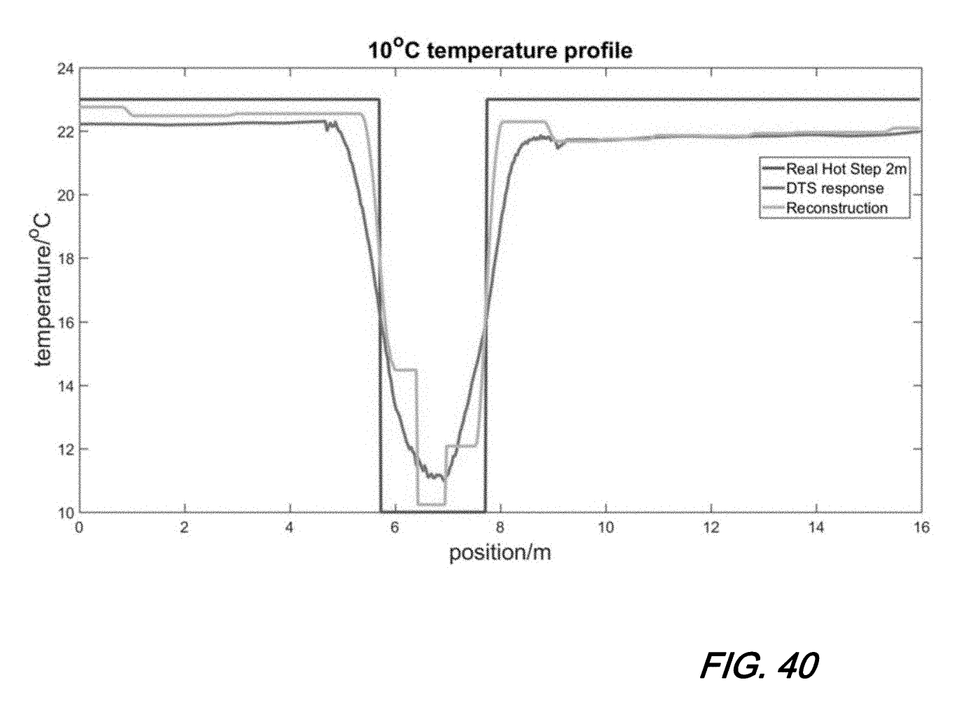

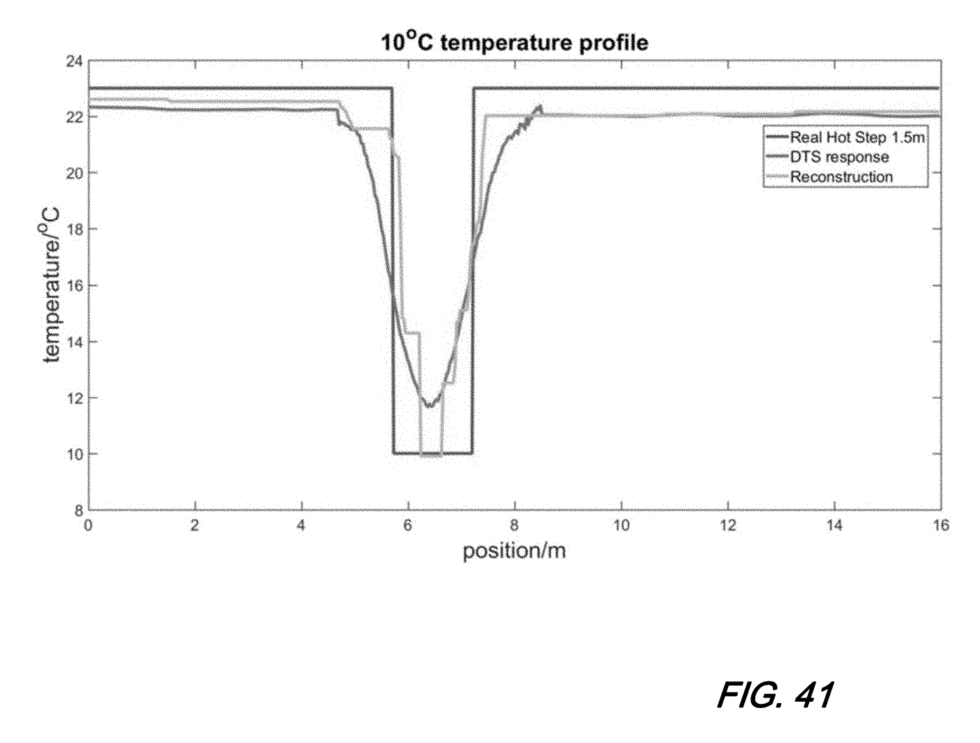

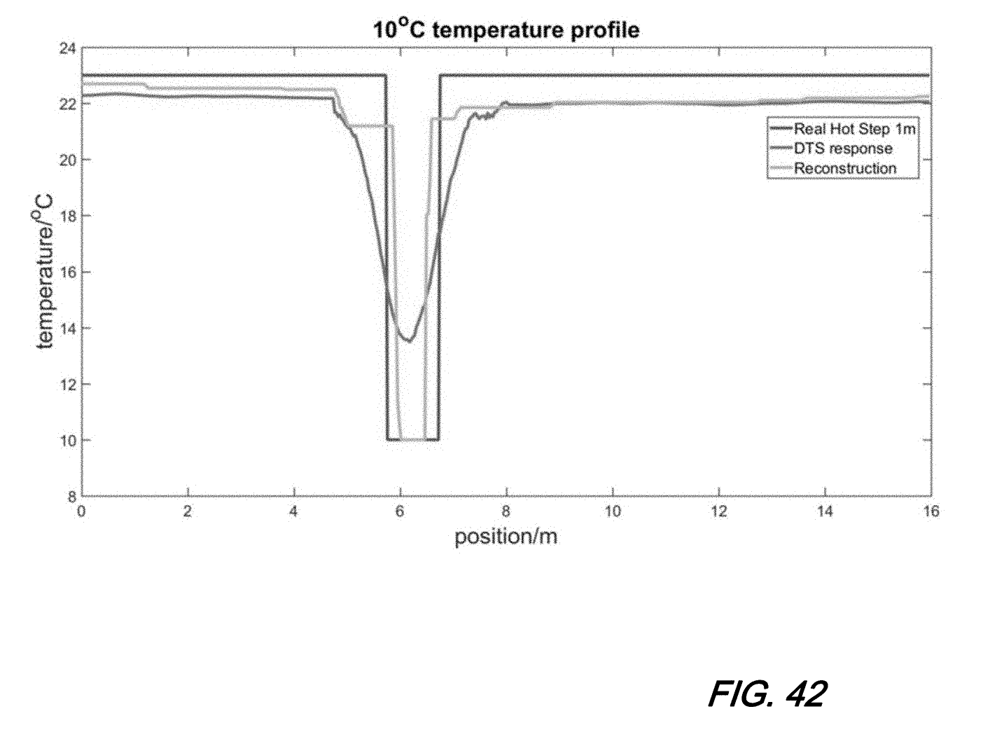

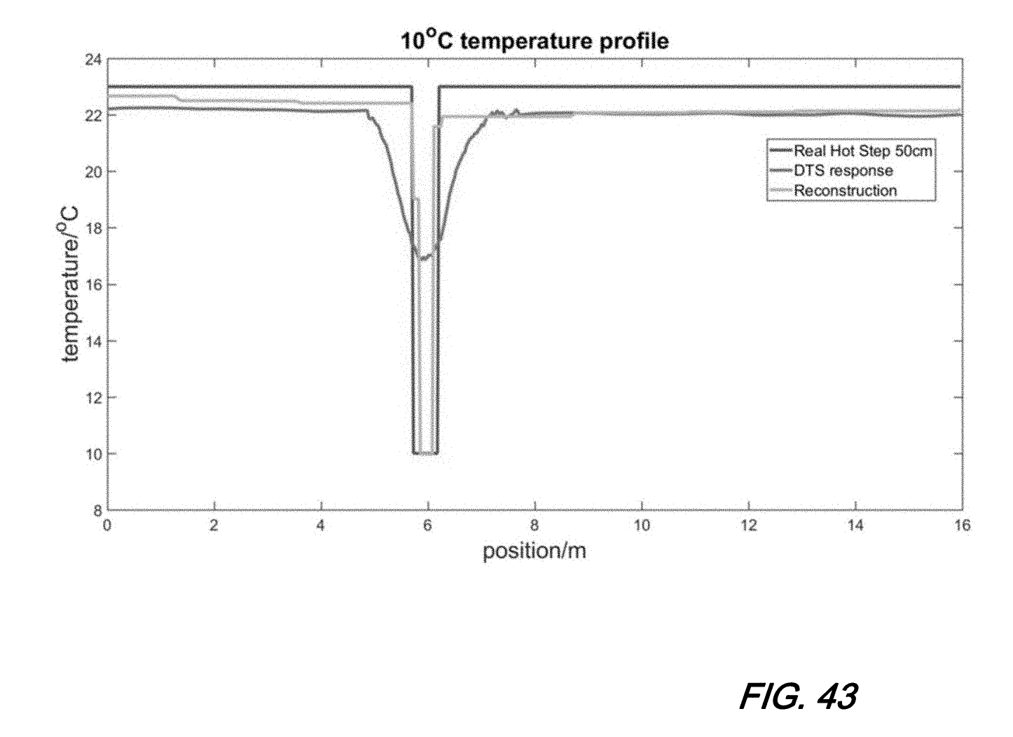

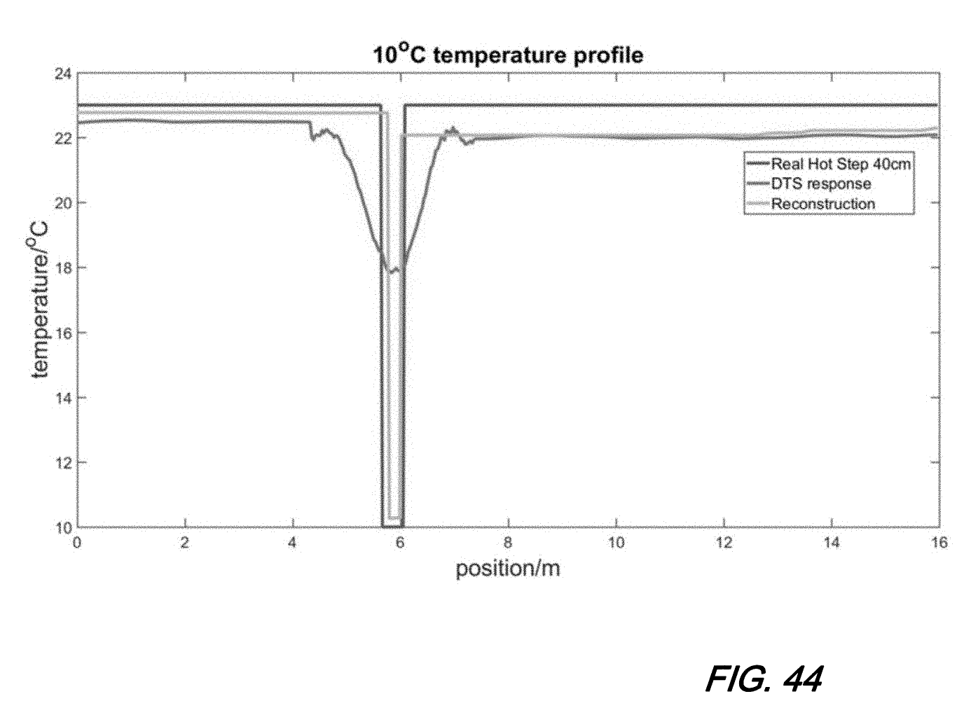

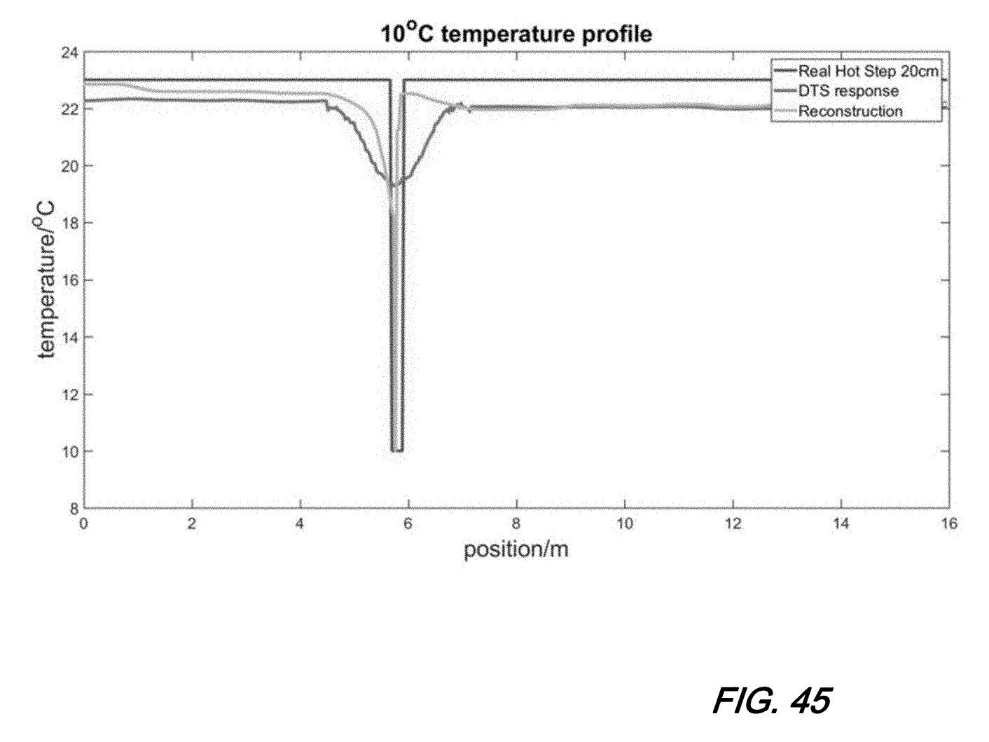

Next, we show more results on reconstruction of signals with low temperature. The system matrix H is trained by 9 signals with length of 20 cm, 50 cm and 1.5 m, and at 2.1° C., 50° C. and 85° C. Signals to be reconstructed are at 10° C. with different length. The results are shown in FIGS. 39-45 in which: FIG. 39 is a 10° C. temperature profile plot of temperature ° C. vs. position/m for a 10° C. 3 m reconstruction according to aspects of the present disclosure; FIG. 40 is a 10° C. temperature profile plot of temperature ° C. vs. position/m for a 10° C. 2 m reconstruction according to aspects of the present disclosure; FIG. 41 is a 10° C. temperature profile plot of temperature ° C. vs. position/m for a 10° C. 1.5 m reconstruction according to aspects of the present disclosure; FIG. 42 is a 10° C. temperature profile plot of temperature ° C. vs. position/m for a 10° C. 1 m reconstruction according to aspects of the present disclosure; FIG. 43 is a 10° C. temperature profile plot of temperature ° C. vs. position/m for a 10° C. 50 cm reconstruction according to aspects of the present disclosure; FIG. 44 is a 10° C. temperature profile plot of temperature ° C. vs. position/m for a 10° C. 40 cm reconstruction according to aspects of the present disclosure; and FIG. 45 is a 10° C. temperature profile plot of temperature ° C. vs. position/m for a 10° C. 20 cm reconstruction according to aspects of the present disclosure.

### Entire Process

In the preceding discussion, we have described our signal recovery algorithm, which can be applied to various cases. In the next, we are going to depict the whole process when dealing with signals from real applications.

In real applications, there might be many hot or cold regions along the fiber, therefore we firstly want to detect all the meaningful peaks and troughs along the fiber and solve the inverse problem locally and then combine the reconstruction signals together. By reconstructing peak signals locally, we could both avoid reconstruct room temperature signals and reduce the computation time significantly.

Since we need to calculate the inverse of a matrix in (26), and we know the complexity of matrix inverse is O(n³), where n is the number of rows of the matrix, therefore we simplify the calculation by reducing n, i.e. size of the signal. Moreover, because the size of matrix H and length of the signal should match, if we want to recover the whole signal directly, we must have learnt a matrix with size as large as the signal length.

Computation of a very large matrix H is always time-consuming. Most importantly, signals with different length favor different parameters, so a unified set of parameters will not be suitable for every peak signal. If we recover each peak signal locally, then we could find the best parameters λ and U specifically for this signal.

Briefly speaking, this localization idea underlies the following reasons: 1) computation time; 2) size of matrix H and length of the signal should match; 3) no need to recover signal with temperature at room temperature; and 4) reconstruct each peak signal with best parameters.

In what follows, we describe algorithms used in Algorithm 7 Auto tuning, in which we basically search for best parameters λ and U that could give a recovery matching the actual temperature profile very well. Our searching guidelines are as follows:
Since we have no information about actual temperature profile f before running the recovery algorithm (Algorithm 2), our criteria are on the measurement g. By comparing error ∥g−Hfₑₛₜ∥ and TOL, we know if the recovery fₑₛₜ is good enough or not and whether we need to do more searching. By comparison between the maximum of Hfₑₛₜ and g, we know which direction to go.
Usually, we expect positive correlation between fₑₛₜ and Hfₑₛₜ, and we tend to tune λ first, then U. So, if max Hfₑₛₜ<max g, we reduce λ to increase fₑₛₜ, and Hfₑₛₜ too; if max Hfₑₛₜ≥max g, we increase λ to decrease fₑₛₜ and H fₑₛₜ too.
For l<50 cm, since l is too short, the temperature is too low, thus tuning on λ only is not enough to reconstruct a good temperature profile. Usually, we need to both increase U and decrease λ.
Initial parameters for searching are empirically determined to reduce the searching space. For fine tuning, we're looking for a pair of parameters λh and λh or Uₗ and Uₕ correspond to recovery signal fₑₛₜ's such that Hf_{est-low} and Hf_{est-high}, then bisection search is conducted between that pair of parameters to search for the parameter gives smallest error.

Algorithm 3 Bisection search

if |g − Hfest| >TOL and max Hfest ≥ max g then

λₕ ← λ

else if |g − Hfest| >TOL and max Hfest < max g then

λₗ ← λ

else

return λ, U and f ← fest

end if

Algorithm 4 Search high

if |g − Hfest|>TOL and max Hfest < max g then

λₗ ← λ, and λ ← (λₕ + λₗ)/2
run Algorithm 2, and return fest
run Algorithm 3 for MAXITER times
return f as fest with minimum error |g − Hfest| and the
associated parameters λ and U

else if |g − Hfest|>TOL and max max Hfest ≥ max g then

λ_{H} ← λ
generate a (MAXITER+1)-term arithmetic progression, with λₕ
as initial

term and λ_{H} as last term

return f as fest with minimum error |g − Hfest| and the
associated parameters λ and U

else

return λ, U and f ← fest

end if

Algorithm 5 Search low

if |g − Hfest|>TOL and max Hfest ≥ max g then

λₕ ← λ, and λ ← (λₕ + λₗ)/2
run Algorithm 2, and return fest
run Algorithm 3 for MAXITER times
return f as fest with minimum error |g − Hfest|and the
associated
parameters λ and U

else if |g − Hfest|>TOL and max Hfest < max g then

λ_{L} ← λ
generate a (MAXITER+1)-term arithmetic progression, with λₗ
as initial

term and λ_{L} as last term

return f as fest with minimum error |g − Hfest|and the associated
parameters λ and U

else

return λ, U and f ← fest

end if

Algorithm 6 Search run Algorithm 2, and return fest

if |g − Hfest|>TOL and max Hfest ≥ max g then

γₕ ← λ, and λ ← λ₁
run Algorithm 2, and return fest
run Algorithm 4

else if |g − Hfest|>TOL and max max Hfest < max g then

λₗ ← λ, and λ ← λ₂
run Algorithm 2, and return fest
run Algorithm 5

else

return λ, U and f ← fest

end if

Algorithm 7 Auto tuning (see MATLAB code AutoTuning.m)

if l ≥1m then

λ ← 5, U ← 5, λ₁ ← 10 and λ₂ ← 1
run Algorithm 6, and return fest

else if 50cm ≤ l <1m then

λ ← 1, U ← 5, λ₁ ← 5 and λ₂ ← 0.1
run Algorithm 6, and return fest

else if 20cm ≤l <50cm then

run more complicated search like Algorithm 6, and return fest

else if 10cm ≤ l <20cm then

run more complicated search like Algorithm 6, and return fest

else

stop, too short fiber, out of interest.

end if

Note: When l≤50 cm, the tuning process is much more complicated, since we're searching for both best λ and U, but it's basically like what we do for only one parameter λ for longer length. Details are in MATLAB code AutoTuning.m. Combining all efforts above, we could do the following steps to reconstruct an arbitrary signal.

### Reconstruction of Arbitrary Signal (See MATLAB Code WholeProcess.m)

1. auto division and length estimation by peak analysis in MATLAB (see MATLAB code Length-EstimationAutoDivisionByPeakAnalysis.m) Use peak analysis to detect all peaks with high prominence, predict length l based on the half-prominence length lₑ and statistical data (linear regression if lₑ>1.2 m, interpolation if lₑ≥1.2 m). Extend the length l by 10% to both left and right side, and cut out this segment of signal for reconstruction. If needed (when size of matrix H and length of signal don't match), pad room temperature to the signal.
2. auto tuning by recovery algorithm
   Set tolerance TOL and max number of iteration MAXITER.
   For each cut out signal, always keep L=1, tune λ and U by running Algorithm 7 Auto tuning.
3. reconstruct locally and combine globally
   Reconstruct peak signal with best parameter found in step (2) locally.
   Combine all the recovered signals with other unrecovered signals.

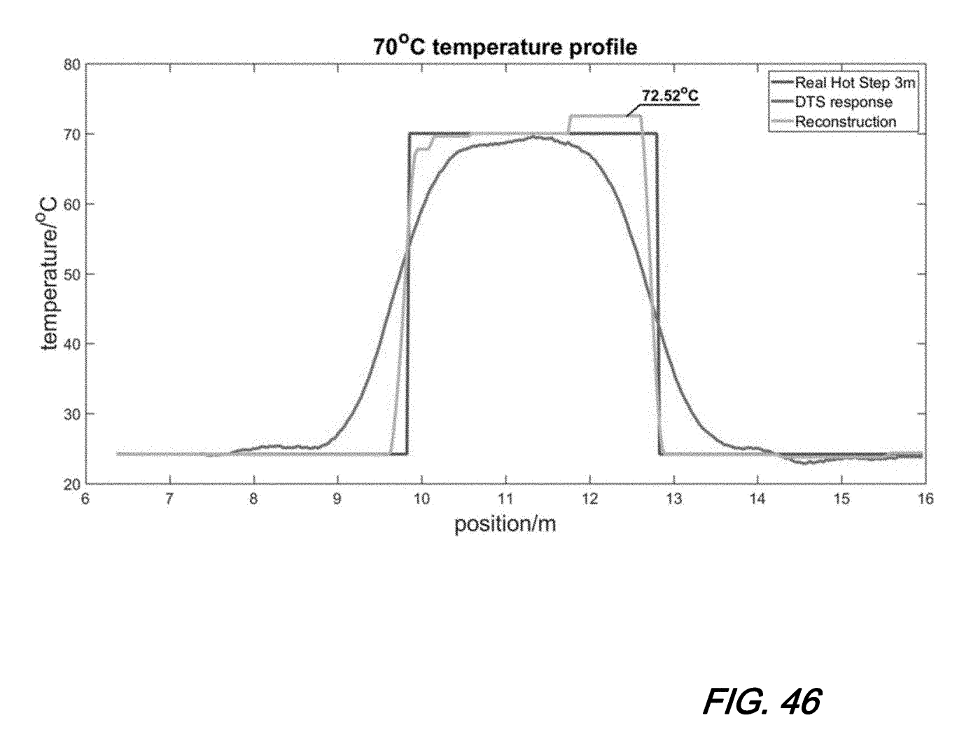

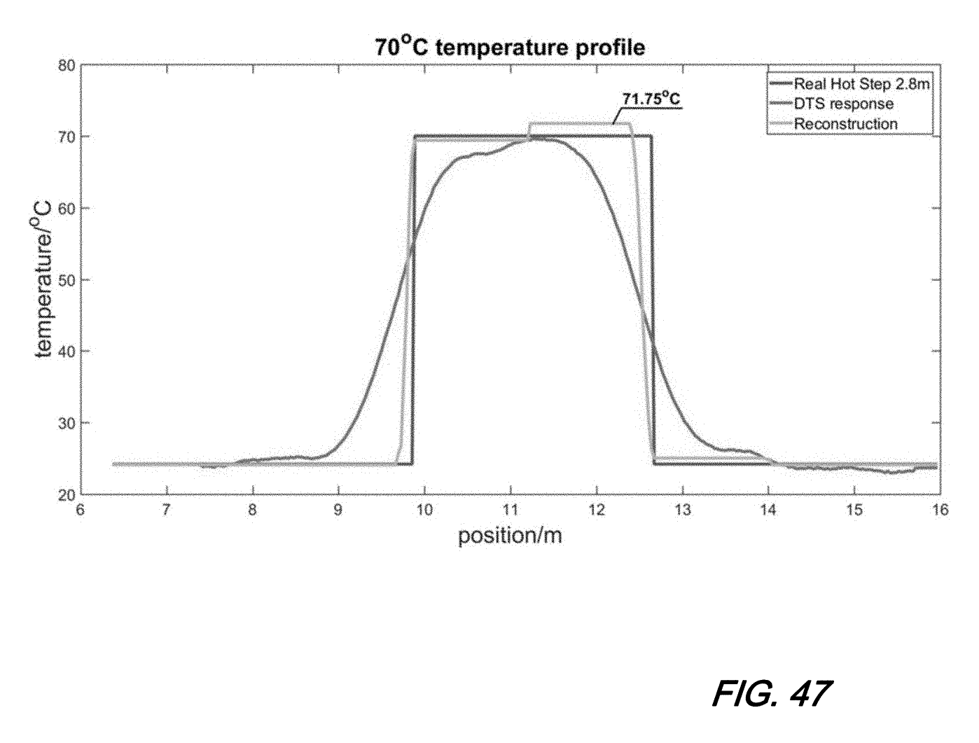

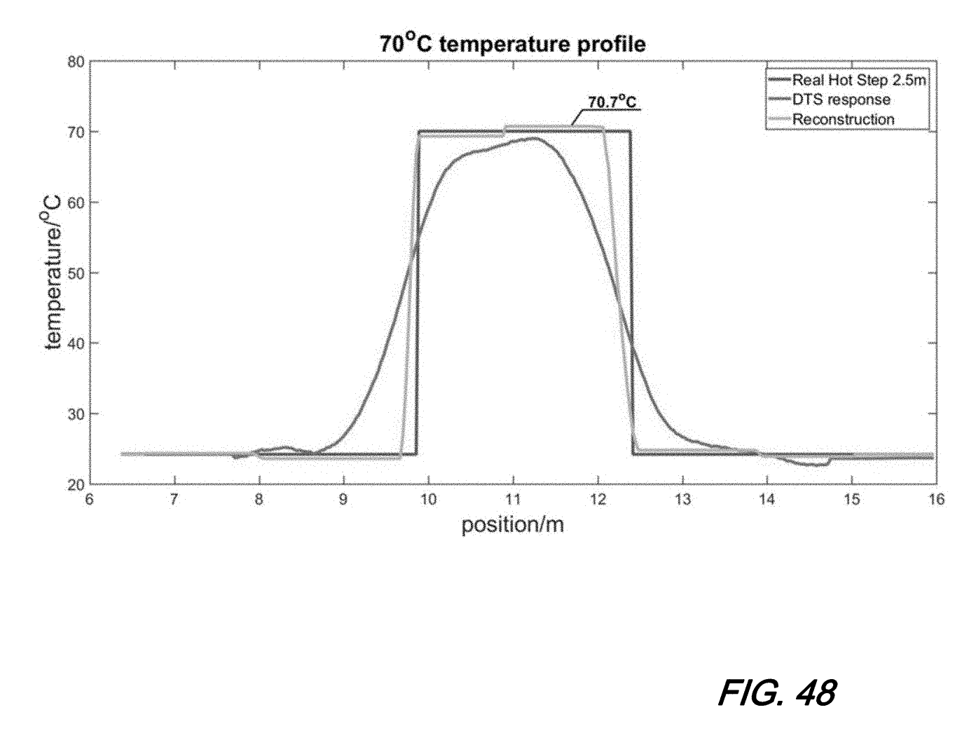

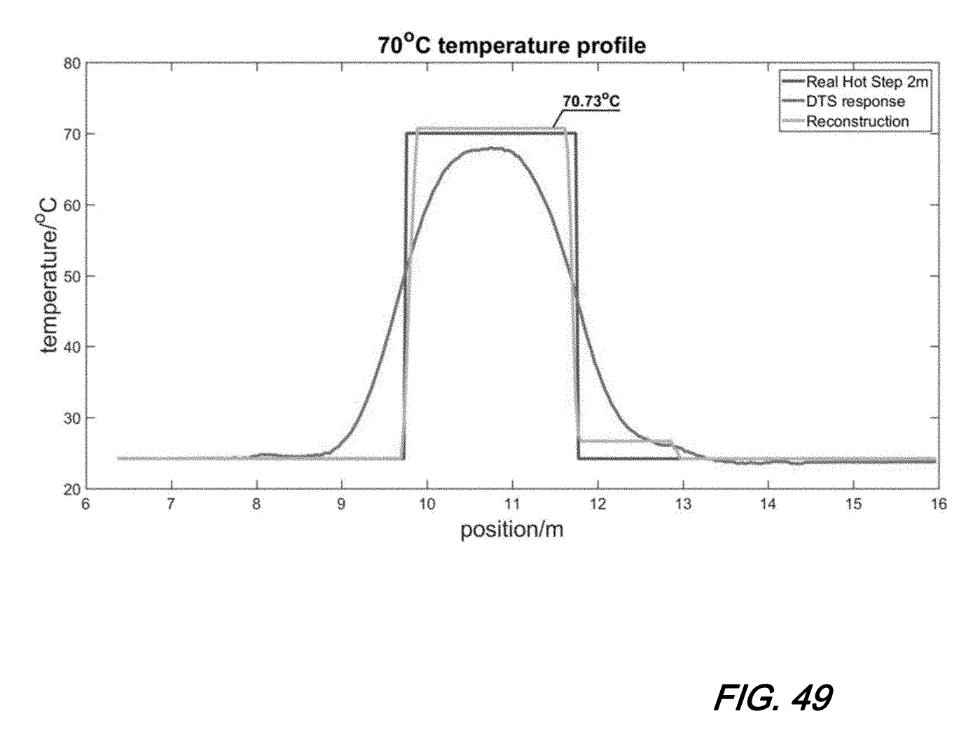

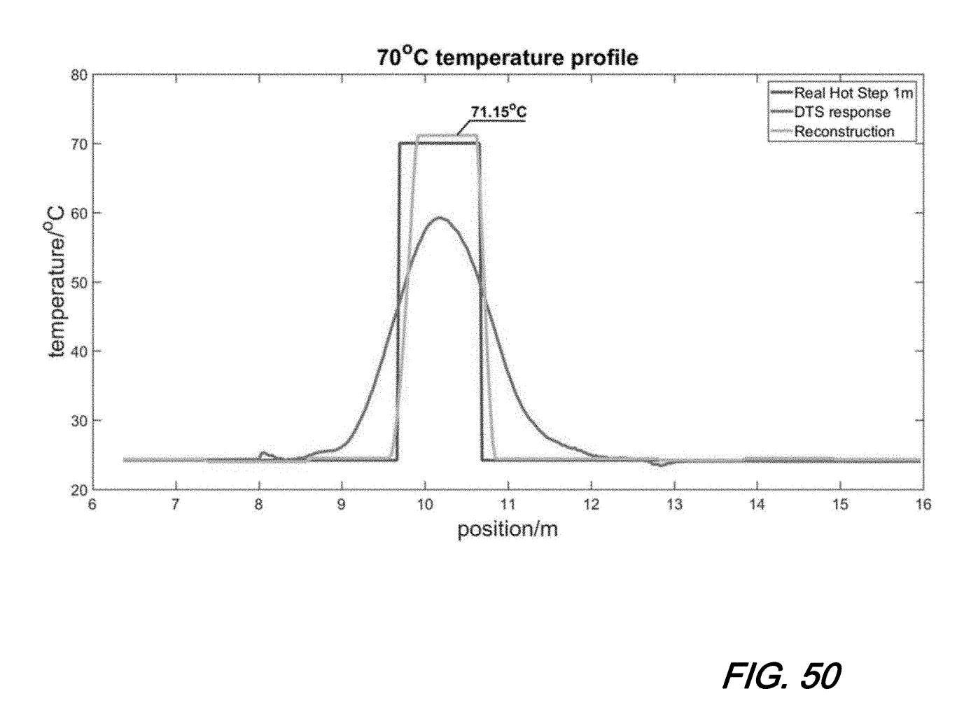

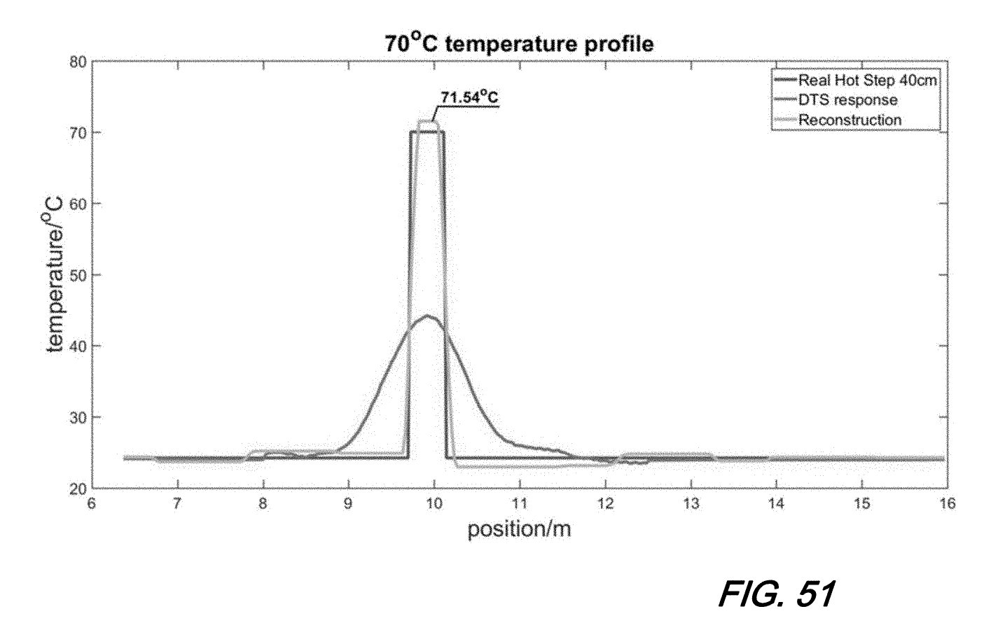

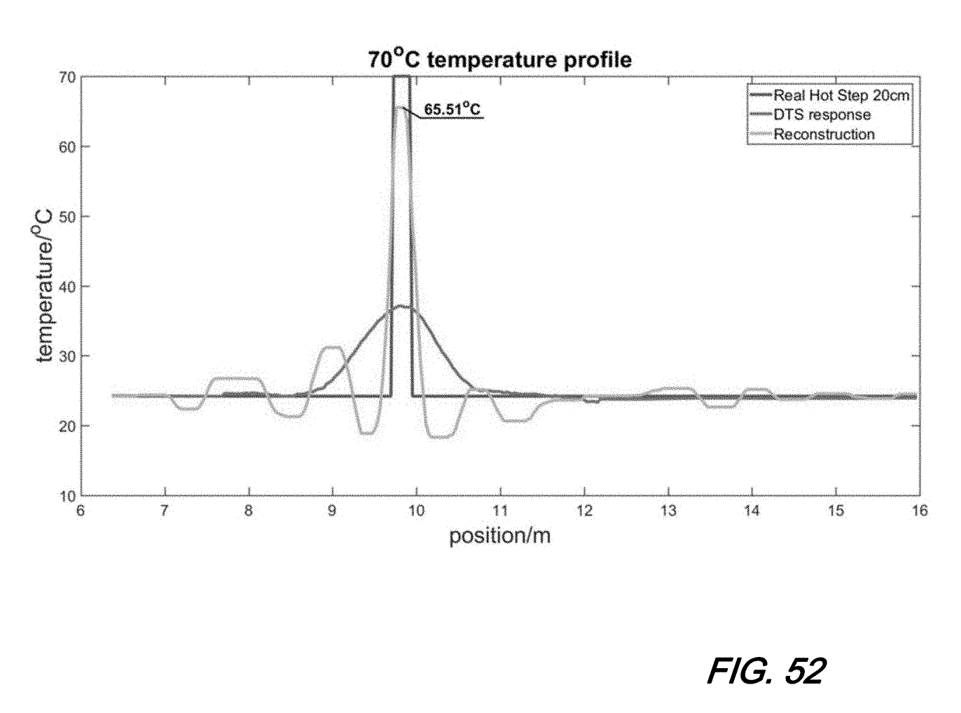

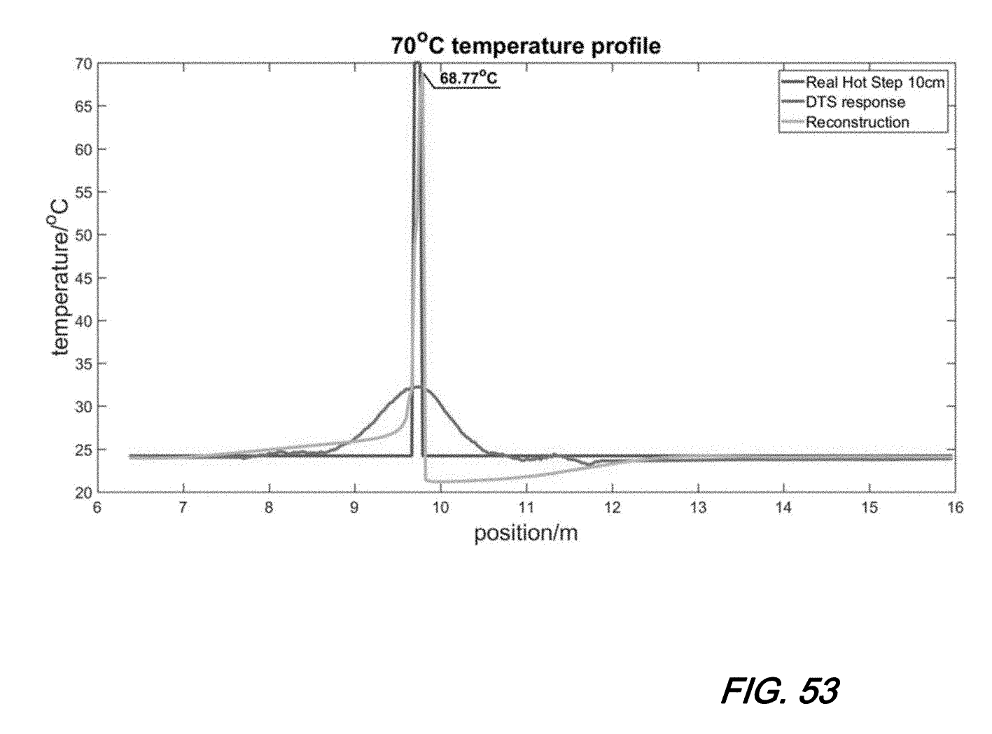

We could test our reconstruction procedure on signal with single hot source as shown in FIGS. 46-53 in which FIG. 46 is a 70° C. temperature profile plot of temperature ° C. vs. position/m for a 70° C. 3 m reconstruction on signal with single hot source according to aspects of the present disclosure; FIG. 47 is a 70° C. temperature profile plot of temperature ° C. vs. position/m for a 70° C. 2.8 m reconstruction on signal with single hot source according to aspects of the present disclosure; FIG. 48 is a 70° C. temperature profile plot of temperature ° C. vs. position/m for a 70° C. 2.5 m reconstruction on signal with single hot source according to aspects of the present disclosure; FIG. 49 is a 70° C. temperature profile plot of temperature ° C. vs. position/m for a 70° C. 2 m reconstruction on signal with single hot source according to aspects of the present disclosure; FIG. 50 is a 70° C. temperature profile plot of temperature ° C. vs. position/m for a 70° C. 1 m reconstruction on signal with single hot source according to aspects of the present disclosure; FIG. 51 is a 70° C. temperature profile plot of temperature ° C. vs. position/m for a 70° C. 40 cm reconstruction on signal with single hot source according to aspects of the present disclosure; FIG. 52 is a 70° C. temperature profile plot of temperature ° C. vs. position/m for a 70° C. 20 cm reconstruction on signal with single hot source according to aspects of the present disclosure; and FIG. 53 is a 70° C. temperature profile plot of temperature ° C. vs. position/m for a 70° C. 10 cm reconstruction on signal with single hot source according to aspects of the present disclosure.

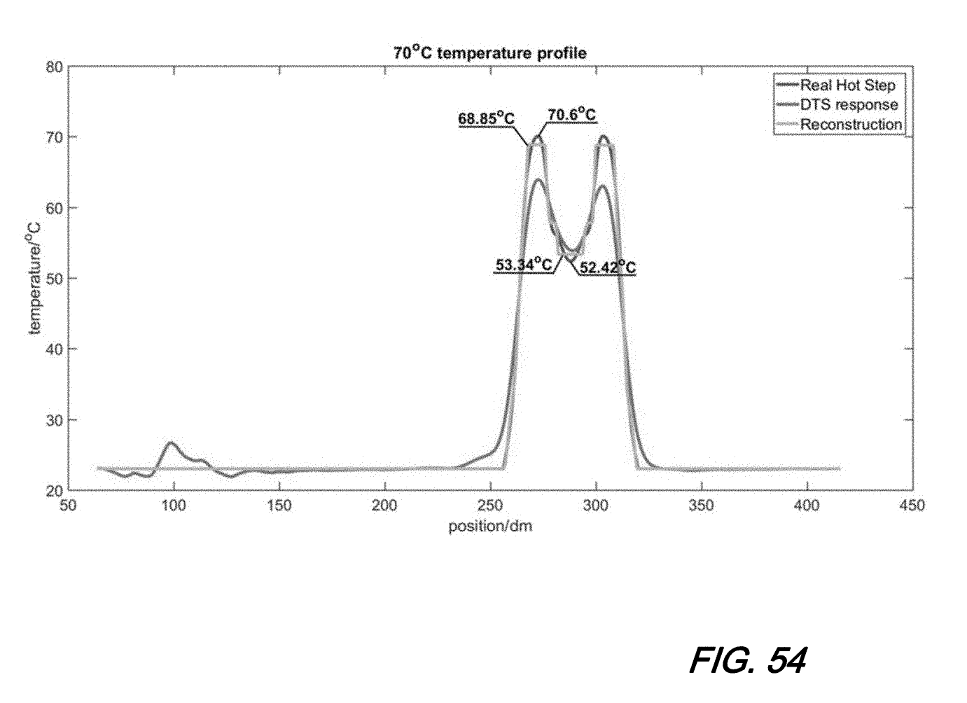

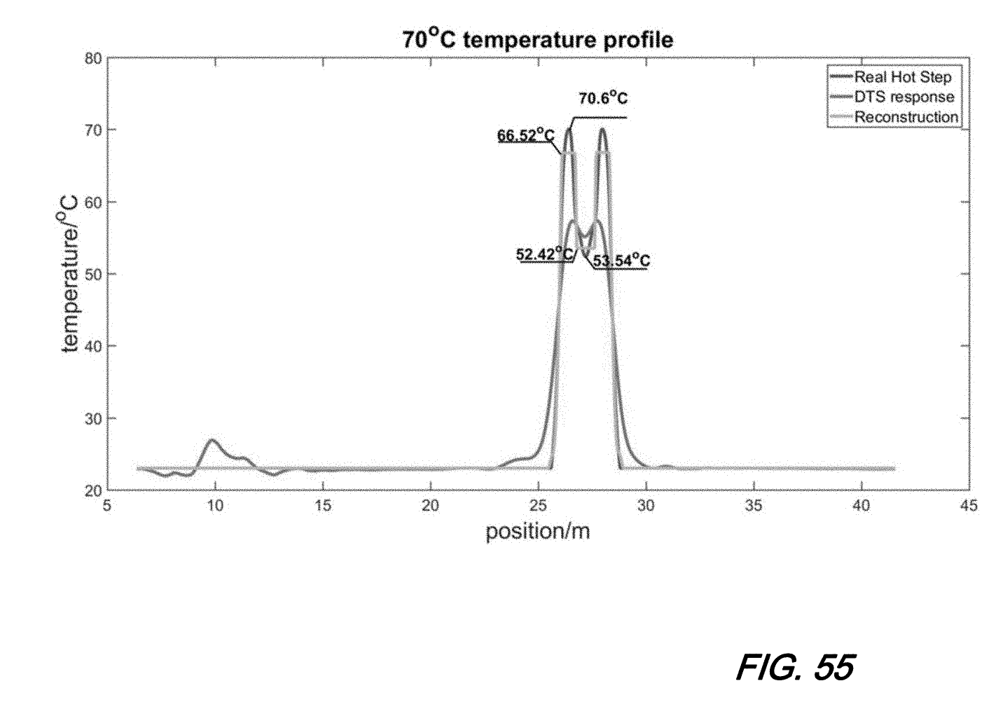

Multiple hot sources are shown in FIG. 54-FIG. 55 in which: FIG. 54 is a 70° C. temperature profile plot of temperature ° C. vs. position/m for a 70° C. 3 m reconstruction on signal with multiple hot sources according to aspects of the present disclosure; and FIG. 55 is a 70° C. temperature profile plot of temperature ° C. vs. position/m for a 70° C. reconstruction on signal with multiple hot sources according to aspects of the present disclosure.

Note that with respect to FIG. 52, we can see the recovery result for 20 cm is not good enough, since the highest temperature is 4.5° C. lower than the actual temperature 70° C. and too much noise is introduced. We should note that this is not the best result we could achieve if we do it manually.

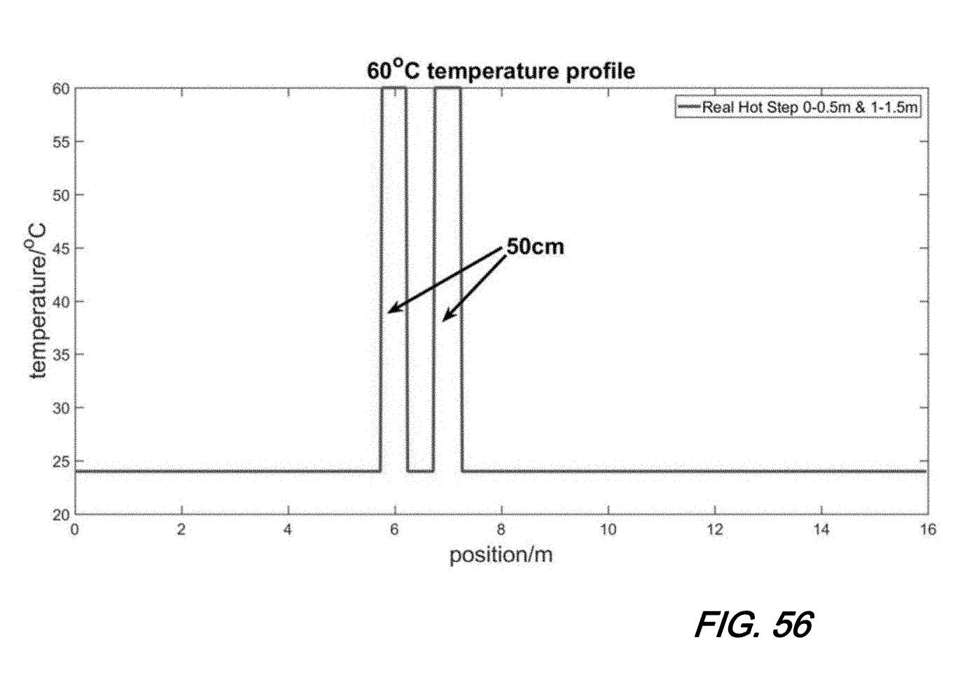

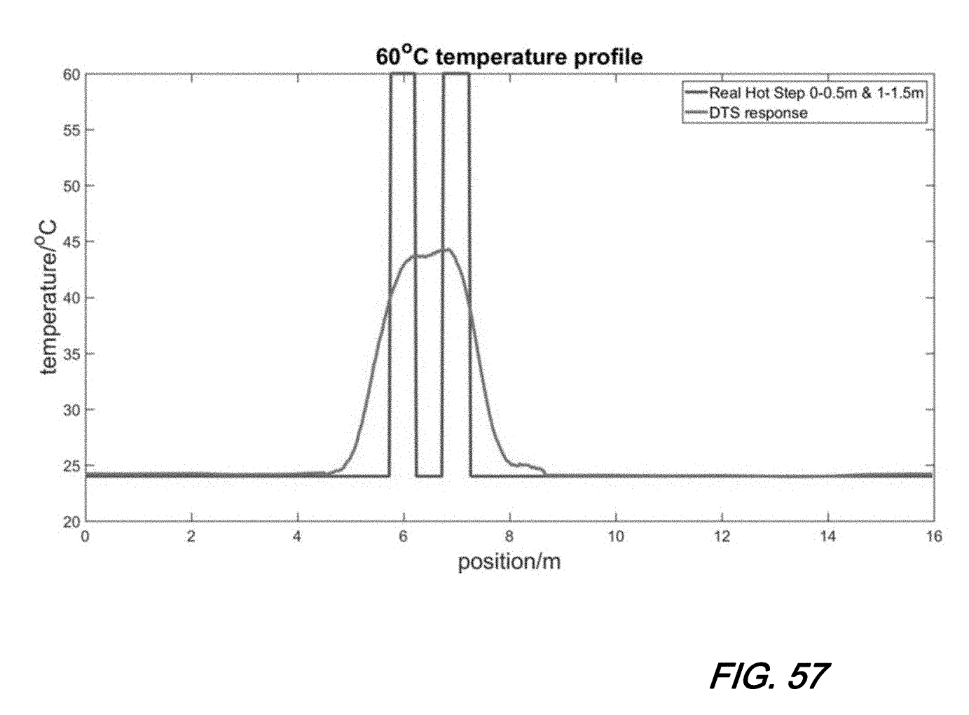

The reconstruction in FIG. 52 is achieved with U=5, λ=0.01 given by auto tuning, while we could manually tune the parameters to recover a better temperature profile with U=50, λ=0.01, see, e.g., FIG. 56.

In Table 1, we list experiments performed to test our whole process reconstruction procedure.

TABLE 1
Reconstruction experiments

| Length/cm | L | U | λ | error |
|---|---|---|---|---|
| 10 | 1 | 1000 | 0.001 | −1.13 |
| 20 | 1 | 5 | 0.01 | −4.49 |
| 40 | 1 | 5 | 0.1 | 1.54 |
| 50 | 1 | 5 | 0.1 | 2.47 |
| 80 | 1 | 5 | 0.1 | 1.98 |
| 100 | 1 | 5 | 1 | 1.15 |
| 120 | 1 | 5 | 1 | 4.13 |
| 150 | 1 | 5 | 1 | 2.06 |
| 180 | 1 | 5 | 5 | 0.68 |
| 200 | 1 | 5 | 5 | 0.73 |
| 220 | 1 | 5 | 5 | −0.24 |
| 250 | 1 | 5 | 1 | 0.7 |
| 280 | 1 | 5 | 4.9375 | 1.75 |
| 300 | 1 | 5 | 1 | 2.52 |

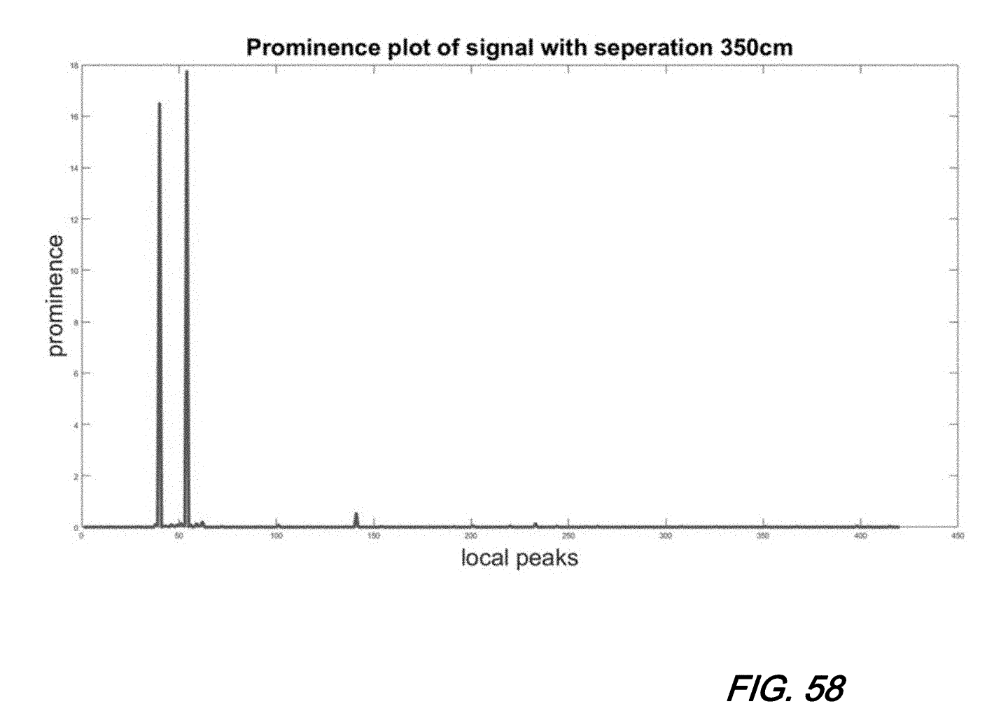

Furthermore, we'd like to test the whole process on signals with multiple peaks. Source separation is a good scenario where we could test our method. When two adjacent hot regions are close, the measurement could merge to be only one peak, due to the low-pass characteristics of the DTS system. For example, the measurement (in red) shown in FIG. 58 merged together, so that we couldn't distinguish the two regions in our DTS readings. In the following, we test our method on 7 measurements, for the corresponding real temperature profile f, each one has two peaks signals with length of 50 cm at 60° C., and the two peaks are separated by 350 cm, 300 cm, 250 cm, 200 cm, 150 cm, 100 cm and 50 cm.

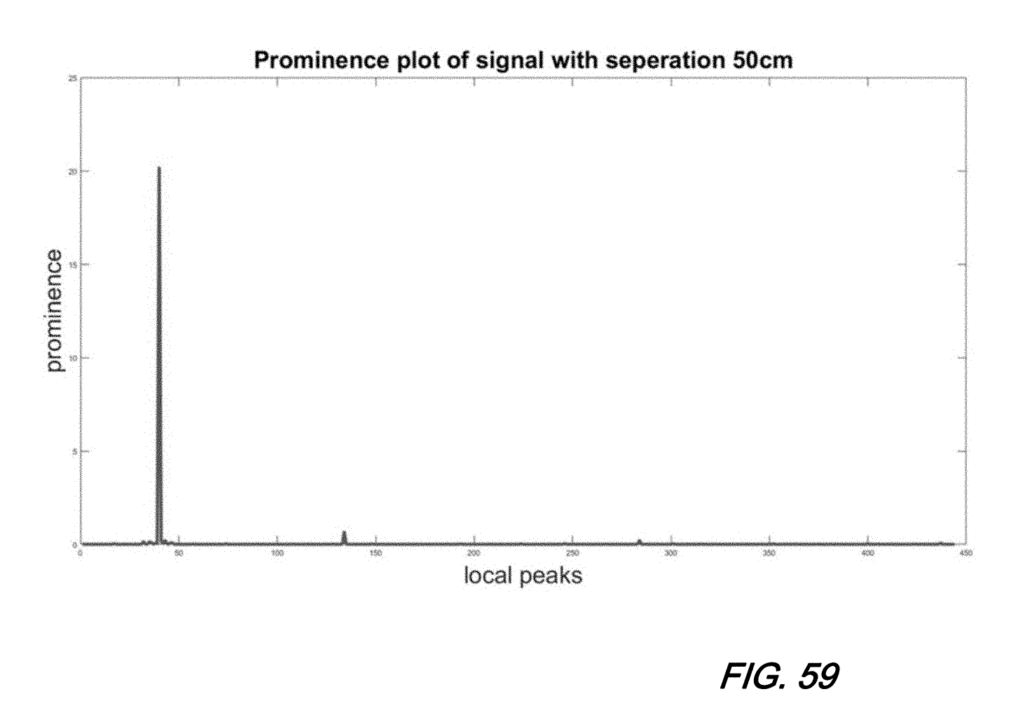

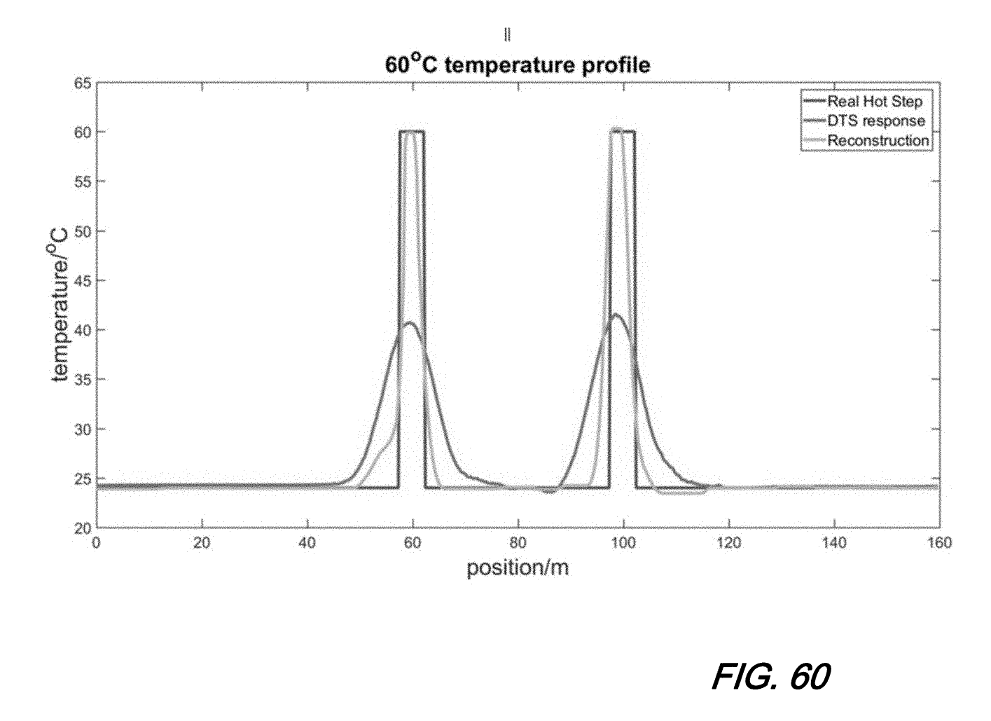

Based on auto division (using MATLAB peak analysis), we could find two peaks in the signals with separation >50 cm, see the prominence (p in [pks,locs,w,p]=findpeaks(signal,‘Annotate’,‘extents’);) plot in FIG. 59 in which a prominence plot of signal with separation of 50 cm according to aspects of the present disclosure is shown. For signal with peaks separated by 50 cm, a prominence plot shows only one peak as shown in FIG. 60 which is a 60° C. temperature profile plot of temperature ° C. vs. position/m illustrating 350 cm separation according to aspects of the present disclosure.

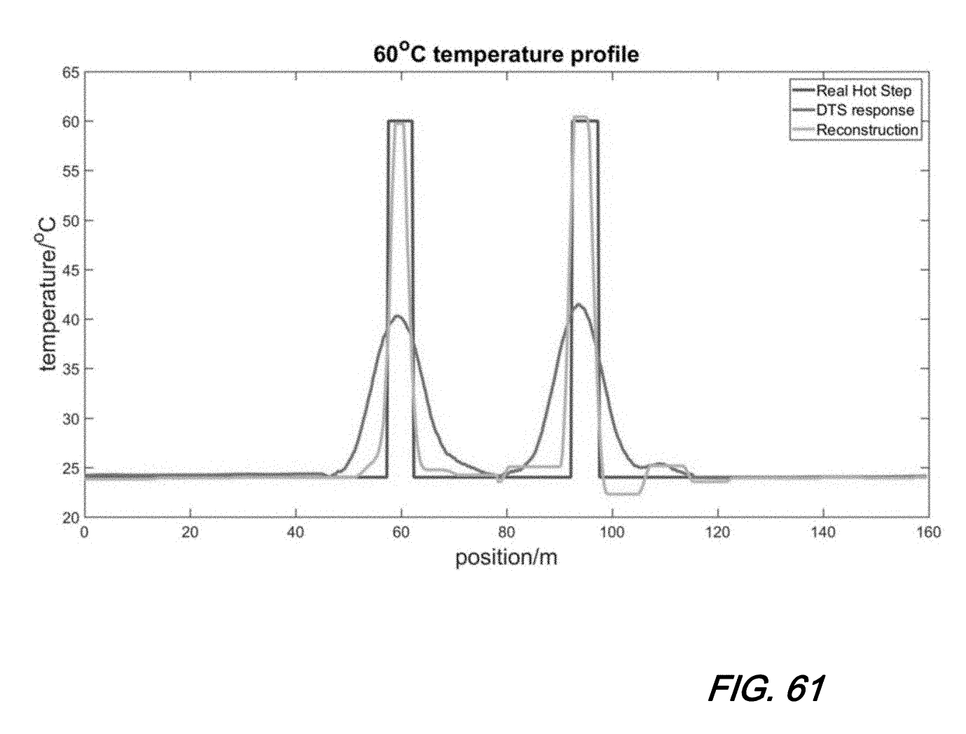

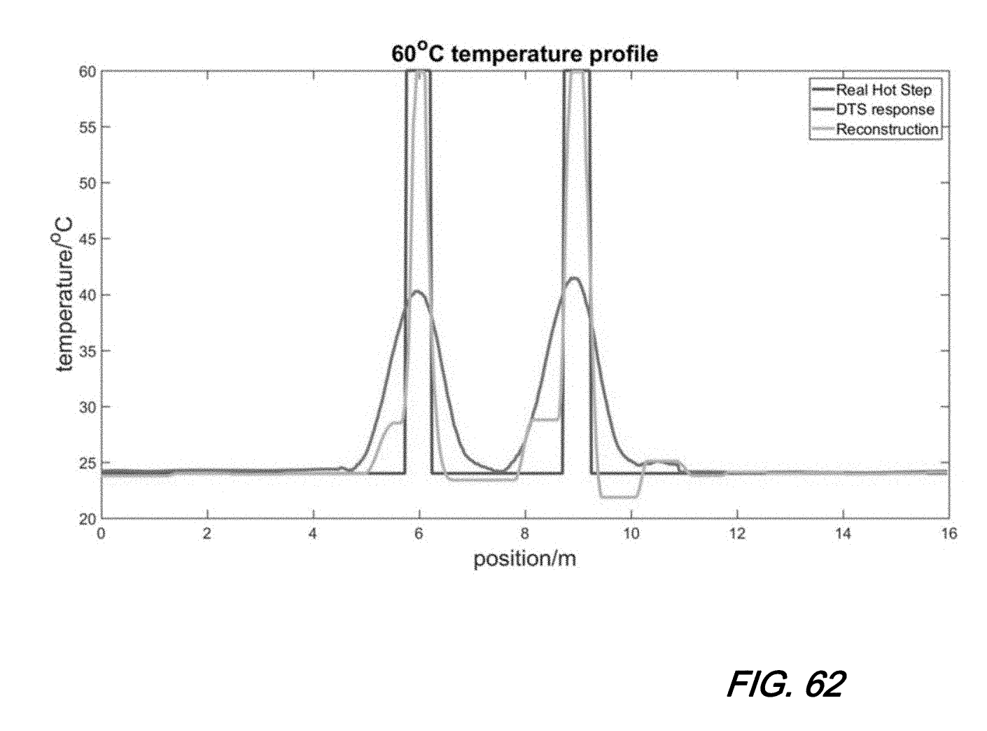

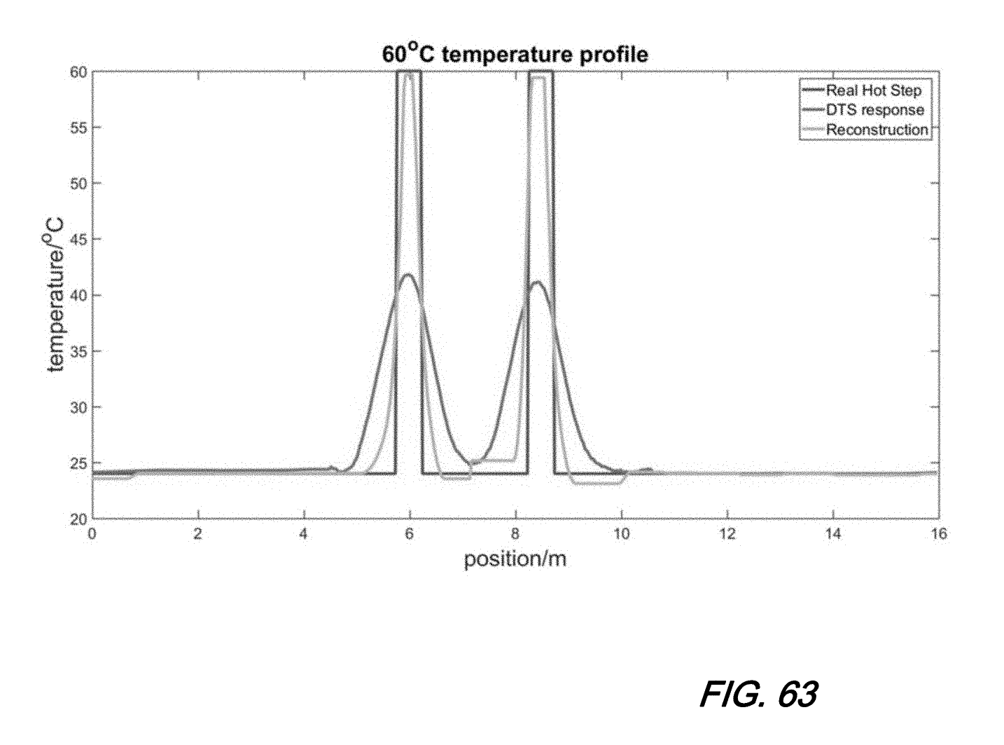

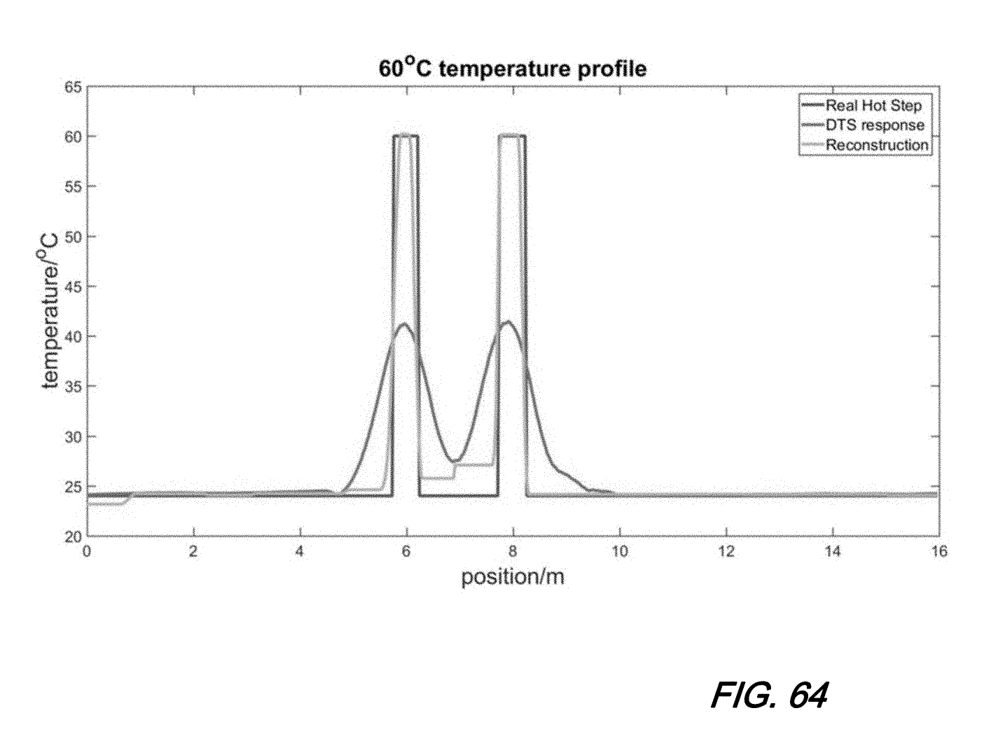

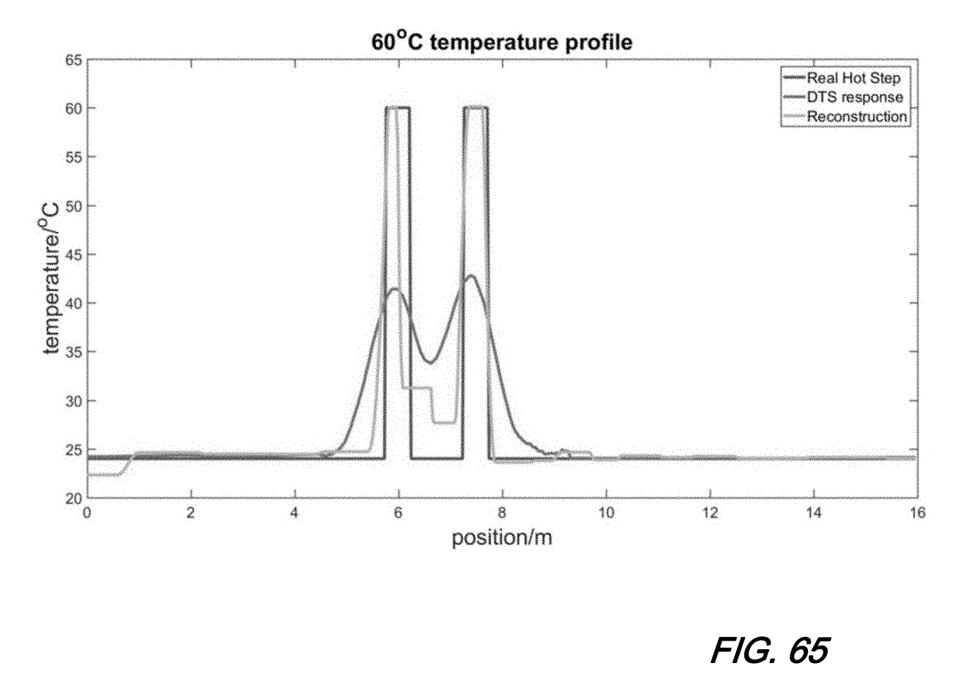

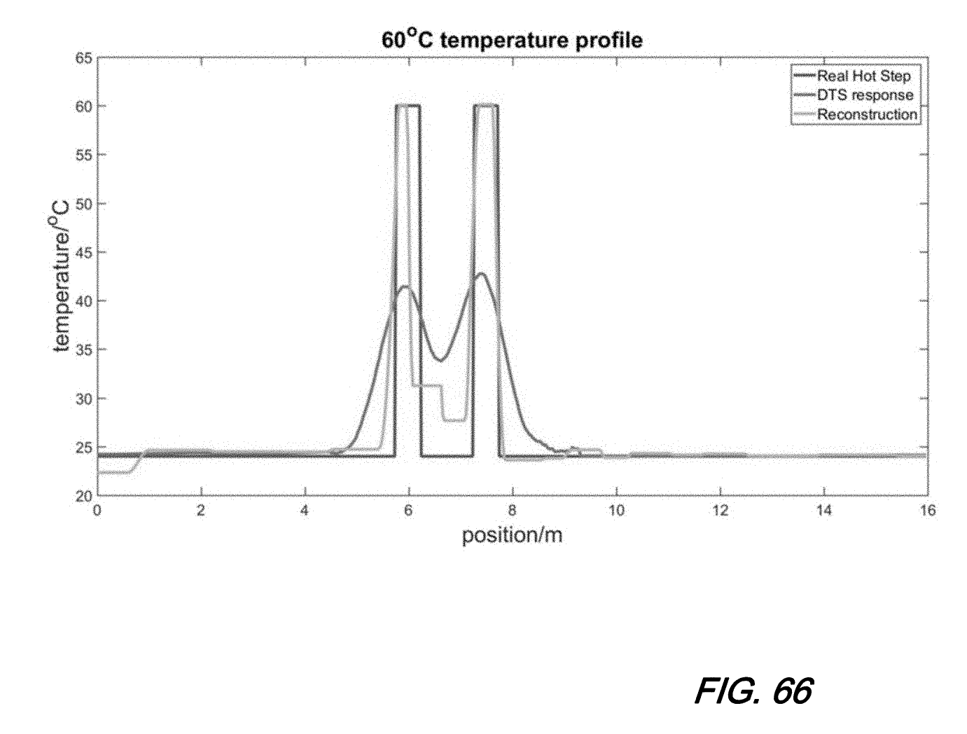

Consequently, a signal with 2 peaks should be cut into two pieces and padded with value at the end point to have 2000 points, which is the size of the system matrix H in the experiments. After recovery of each peak, the two constructions should be combined to serve as the reconstruction of original signal. See FIGS. 61-66 for reconstruction results in which: FIG. 61 is a 60° C. temperature profile plot of temperature ° C. vs. position/m illustrating 300 cm separation according to aspects of the present disclosure; FIG. 62 is a 60° C. temperature profile plot of temperature ° C. vs. position/m illustrating 250 cm separation according to aspects of the present disclosure; FIG. 63 is a 60° C. temperature profile plot of temperature ° C. vs. position/m illustrating 200 cm separation according to aspects of the present disclosure; FIG. 64 is a 60° C. temperature profile plot of temperature ° C. vs. position/m illustrating 150 cm separation according to aspects of the present disclosure; FIG. 65 is a 60° C. temperature profile plot of temperature ° C. vs. position/m illustrating 100 cm separation according to aspects of the present disclosure; and FIG. 66 is a 60° C. temperature profile plot of temperature ° C. vs. position/m illustrating 50 cm separation according to aspects of the present disclosure.

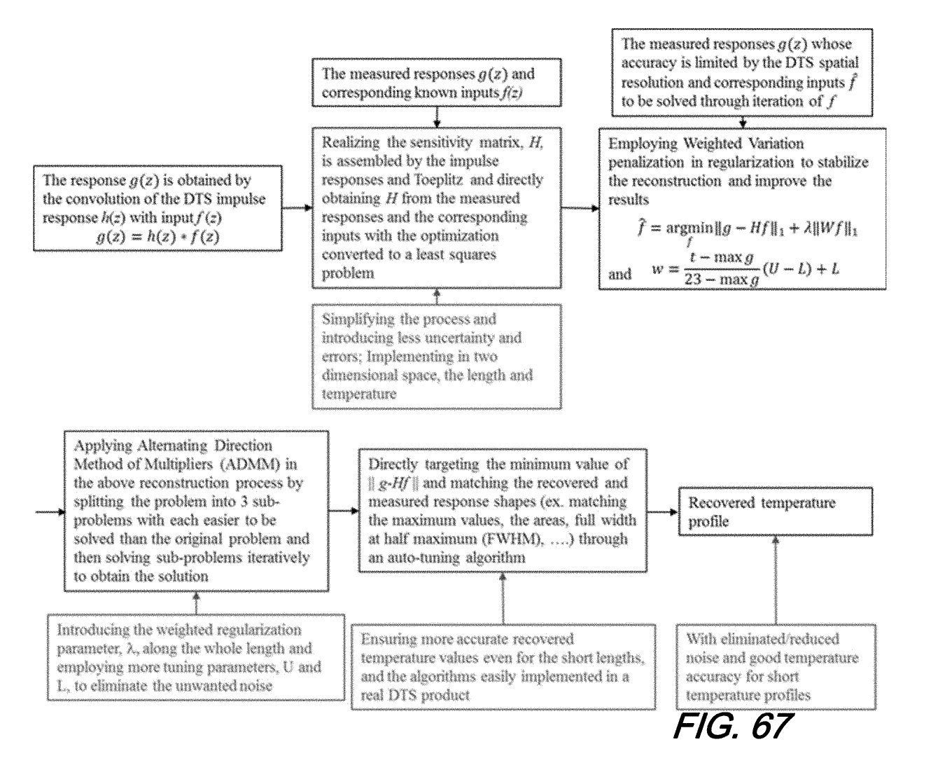

FIG. 67 is a flow diagram illustrating method steps that provide a number of advantages over the art and according to aspects of the present disclosure. Of particular interest, we note that the in a typical DTS system, a laser pulse is sent into an optical fiber that may experience different environmental conditions (i.e., temperature) over its length, and scattered light is reflected back. A detector detects the reflected light and from the intensity of Raman scattering, a temperature determination is made.

Upon determining a response g(z) to a stimulus (input) f(z), we note that the response is obtained by a convolution of the DTS impulse response h(z) with input f(z) such that g(z)=h(z)*f(z). Realizing that the sensitivity matrix H, is assembled by the impulse responses and a Toeplitz matrix, and directly obtaining H from the measured responses and the corresponding inputs with the optimization is converted to a least squares problem. This advantageously simplifies the process and introduces less uncertainty and errors. It may be implemented in two dimensional space including length and temperature.

The measured responses exhibit an accuracy that is limited by the DTS spatial resolution, accordingly a weighted variation penalization in regulation is employed to stabilize and improve the results.

An alternating direction method of multipliers (ADMM) is employed in the reconstruction process by splitting the problem into at least 3 sub problems wherein each one of the individual problems are easier to solver than an original, undivided problem, then solving the subproblems iteratively to obtain the solution. We note that by introducing a weighted regularization parameter, lambda, along the whole length and employing additional tuning parameters, unwanted noise is eliminated.

Finally, by targeting a minimum value and matching the recovered and measured response shapes (i.e., matching maximum values, areas, full width, half maximum) through an auto tuning mechanism, we ensure that more accurate recovered temperature values are obtained even for short lengths. As will be appreciated and understood, by eliminating reduced noise and temperature accuracy for short temperature profiles, superior temperature results are obtained.

### SUMMARY

In this disclosure, we have described a novel deconvolution algorithm to improve the spatial resolution of DTS system. Operationally, a linear model for the DTS and a weighted total variation reconstruction model to recover temperature signals from raw DTS signal was advantageously employed. We further describe a much simplified method of system identification to learn a matrix representing the DTS system. Advantageously, a weighted total variation is introduced to stabilize the reconstruction and reduce noise amplification. Moreover, we disclosed an entire process to re-construct arbitrary signal by using recovery algorithm for each peak signal locally with auto-tuned best parameters.

Accordingly, our results show that it's possible to correctly measure temperature variations in lengths as short as 10 cm. This is a significant improvement compared with the spatial resolution of 1 m determined by the hardware and the current state of the art.

Of particular significance, our recovery algorithm is good enough to reconstruct any signal with ideal parameters. We note that we can find best parameters by searching in an empirically predetermined parameter space.

At this point, while we have presented this disclosure using some specific examples, those skilled in the art will recognize that our teachings are not so limited. Accordingly, this disclosure should be only limited by the scope of the claims attached hereto.

1. A an improved method for distributed temperature sensing (DTS) in which an optical impulse f(z) is introduced into an optical fiber and a response g(z) is obtained by a convolution of the DTS impulse response h(z) with input f(z) such that g(z)=h(z)*f(z) said method CHARACTERIZED BY:
a sensitivity matrix H is obtained from the response(s) and introduced impulse(s) in two-dimensional space including the length and temperature in a weighted variation regularization reconstruction defined by:
$$\hat{f} = {argmin}_{f} {‖ g - Hf ‖}_{1} + λ {‖ Wf ‖}_{1}$$
$$and$$
$$w = \frac{t - max g}{23 - max g} ( U - L ) + L$$
where U, and L represent the temperature and length, respectively.

2. The coding method of claim 1 FURTHER CHARACTERIZED BY:
applying an alternate direction method of multipliers (ADMM) by defining the reconstruction into 3 sub-problems and solving iteratively the sub-problems.
